(19) United States
(12) Patent Application Publication
(10) Pub. No.: US 2024/0022358 A1
(43) Pub. Date: Jan. 18, 2024

(54) MANAGING HARQ TRANSMISSIONS IN MULTICAST COMMUNICATION

(71) Applicant: GOOGLE LLC, Mountain View, CA (US)

(72) Inventor: Chih-Hsiang Wu, Taoyuan City (TW)

(21) Appl. No.: 18/033,448

(22) PCT Filed: Oct. 18, 2021
(86) PCT No.: PCT/US21/55345

§ 371 Date: Apr. 24, 2023

Related U.S. Application Data
(60) Provisional application No. 63/104,307, filed on Oct. 22, 2020.

(51) Int. Cl. H04L 1/1829; H04L 1/08

(52) U.S. Cl. CPC H04L 1/1861; H04L 1/08

(57) ABSTRACT

A base station for providing a multicast and/or broadcast service (MBS), (i) transmits (1202) a protocol data unit (PDU) of an MBS data packet associated with the MBS, using a mechanism for automatic re-transmission of undelivered PDUs, and (ii) receives (1204), on a physical uplink channel and from at least one of the plurality of UEs, an indication of whether a UE successfully received the PDU of the MBS data packet. A user equipment (UE) for receiving MBS (i) attempts (1302) to receive, from the base station, a PDU of an MBS data packet associated with the MBS, and (ii) transmits (1304), on a physical uplink channel and to the base station, an indication of whether the UE successfully received the PDU of the MBS data packet, in accordance with a mechanism for automatic re-transmission of undelivered PDUs.

### FIELD OF THE DISCLOSURE

This disclosure relates to wireless communications and, more particularly, to providing multicast and/or broadcast service (MBS).

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In telecommunication systems, the Packet Data Convergence Protocol (PDCP) sublayer of the radio protocol stack provides services such as transfer of user-plane data, ciphering, integrity protection, etc. For example, the PDCP layer defined for the Evolved Universal Terrestrial Radio Access (EUTRA) radio interface (see 3GPP specification TS 36.323) and New Radio (NR) (see 3GPP specification TS 38.323) provides sequencing of protocol data units (PDUs) in the uplink direction (from a user device, also known as a user equipment (UE), to a base station) as well as in the downlink direction (from the base station to the UE). Further, the PDCP sublayer provides services for signaling radio bearers (SRBs) to the Radio Resource Control (RRC) sublayer. The PDCP sublayer also provides services for data radio bearers (DRBs) to a Service Data Adaptation Protocol (SDAP) sublayer or a protocol layer such as an Internet Protocol (IP) layer, an Ethernet protocol layer, and an Internet Control Message Protocol (ICMP) layer. Generally speaking, the UE and a base station can use SRBs to exchange RRC messages as well as non-access stratum (NAS) messages, and can use DRBs to transport data on a user plane.

The UE in some scenarios can concurrently utilize resources of multiple nodes (e.g., base stations or components of a distributed base station or disaggregated base station) of a radio access network (RAN), interconnected by a backhaul. When these network nodes support different radio access technologies (RATs), this type of connectivity is referred to as Multi-Radio Dual Connectivity (MR-DC). When operating in MR-DC, the cell(s) associated with the base station operating as a master node (MN) define a master cell group (MCG), and the cells associated with the base station operating as a secondary node (SN) define the secondary cell group (SCG). The MCG covers a primary cell (PCell) and zero, one, or more secondary cells (SCells), and the SCG covers a primary secondary cell (PSCell) and zero, one, or more SCells. The UE communicates with the MN (via the MCG) and the SN (via the SCG). In other scenarios, the UE utilizes resources of one base station at a time, i.e., single connectivity (SC). The UE in SC only communicates with the MN (via the MCG). One base station and/or the UE determines that the UE should establish a radio connection with another base station. For example, one base station can determine to hand the UE over to the second base station, and initiate a handover procedure. The UE in other scenarios can concurrently utilize resources of a RAN node (e.g., a single base station or a component of a distributed base station or a disaggregated base station), interconnected by a backhaul.

UEs can use several types of SRBs and DRBs. So-called SRB1 resources carry RRC messages, which in some cases include NAS messages over the dedicated control channel (DCCH), and SRB2 resources support RRC messages that include logged measurement information or NAS messages, also over the DCCH but with lower priority than SRB1 resources. More generally, SRB1 and SRB2 resources allow the UE and the MN to exchange RRC messages related to the MN and embed RRC messages related to the SN, and also can be referred to as MCG SRBs. SRB3 resources allow the UE and the SN to exchange RRC messages related to the SN, and can be referred to as SCG SRBs. Split SRBs allow the UE to exchange RRC messages directly with the MN via lower layer resources of the MN and the SN. Further, DRBs terminated at the MN and using the lower-layer resources of only the MN can be referred as MCG DRBs, DRBs terminated at the SN and using the lower-layer resources of only the SN can be referred as SCG DRBs, and DRBs terminated at the MN or SN but using the lower-layer resources of both the MN and the SN can be referred to as split DRBs. DRBs terminated at the MN but using the lower-layer resources of only the SN can be referred to as MN-terminated SCG DRBs. DRBs terminated at the SN but using the lower-layer resources of only the MN can be referred to as SN-terminated MCG DRBs.

UEs can perform handover procedures to switch from one cell to another, whether in single connectivity (SC) or DC operation. These procedures involve messaging (e.g., RRC signaling and preparation) among RAN nodes and the UE. The UE may handover from a cell of a serving base station to a target cell of a target base station, or from a cell of a first distributed unit (DU) of a serving base station to a target cell of a second DU of the same base station, depending on the scenario. In DC scenarios, UEs can perform PSCell change procedures to change PSCells. These procedures involve messaging (e.g., RRC signaling and preparation) among RAN nodes and the UE. The UE may perform PSCell change from a PSCell of a serving SN to a target PSCell of a target SN, or from a PSCell of a source DU of a base station to a PSCell of a target DU of the same base station, depending on the scenario. Further, the UE may perform handover or PSCell change within a cell for synchronous reconfiguration.

Base stations that operate according to fifth-generation (5G) New Radio (NR) requirements support significantly larger bandwidth than fourth-generation (4G) base stations. Accordingly, the Third Generation Partnership Project (3GPP) has proposed that for Release 15, user equipment units (UEs) support a 100 MHz bandwidth in frequency range 1 (FR1) and a 400 MHz bandwidth in frequency range (FR2). Due to the relatively wide bandwidth of a typical carrier, 3GPP has proposed that for Release 17, a 5G NR base station can provide multicast and/or broadcast service (MBS, also known as MBMS for “multimedia broadcast multicast service”) to UEs that can be useful in many content delivery applications, such as transparent IPv4/IPv6 multicast delivery, IPTV, software delivery over wireless, group communications, IoT applications, V2X applications, emergency messages related to public safety, to name a few.

As described in the work item description in 3GPP RP-201038, 3GPP seeks to improve reliability of MBS for UEs. However, it is not clear how the UEs and base stations can improve reliability of transmissions.

### SUMMARY

Generally speaking, a RAN and/or UE implement a mechanism for automatic retransmission of undelivered packets, such as HARQ, to improve reliability of MBS. To this end, a base station can allocate a single uplink channel for multiple MBSs or respective uplink channel for different MBSs, and UEs can transmit negative and/or positive acknowledgements for MBS packets. When the base station receives a negative acknowledgement, the base station re-transmits the MBS packet of the corresponding MBS or, when a shared uplink channel is used, all the MBSs associated with the uplink channel.

One example embodiment of these techniques is a method implemented in a base station for providing MBS. The method can be executed by processing hardware and includes transmitting a PDU (e.g., a medium access control (MAC) PDU) of an MBS data packet associated with the MBS, using a mechanism for automatic re-transmission of undelivered PDUs, and receiving, on a physical uplink channel and from at least one of the plurality of UEs, an indication of whether a UE successfully received the PDU of the MBS data packet.

Another example embodiment of these techniques a base station including processing hardware configured to execute the method above.

Yet another example embodiment of these techniques is a method in a UE for receiving MBS. The method can be executed by processing hardware and includes attempting to receive, from a base station, a PDU of an MBS data packet associated with the MBS; and transmitting, on a physical uplink channel and to the base station, an indication of whether the UE successfully received the PDU of the MBS data packet, in accordance with a mechanism for automatic re-transmission of undelivered PDUs.

Still another embodiment of these techniques is a UE including processing hardware configured to execute the method above.

### BRIEF DESCRIPTION OF THE DRAWINGS

FIG. 1A is a block diagram of an example system in which a radio access network (RAN) and a user device can implement the techniques of this disclosure for managing HARQ transmissions in multicast communication;

FIG. 1B is a block diagram of an example base station in which a centralized unit (CU) and a distributed unit (DU) can operate in the system of FIG. 1A;

FIG. 2 is a block diagram of an example protocol stack, according to which each of the UEs of FIG. 1A can communicate with base stations of FIG. 1A;

FIG. 3A is a messaging diagram of an example scenario in which a base station of the RAN of FIG. 1A broadcasts or multicasts system information to the UE, enabling the UE to receive MBS data packets using a HARQ process;

FIG. 3B is a messaging diagram of an example scenario in which a base station of the RAN of FIG. 1A transmits RRC messages to the UE, enabling the UE to receive MBS data packets using a HARQ process;

FIG. 4A is a flow diagram of an example method that includes configuring different PUCCHs for respective UEs, enabling each of the UEs to transmit HARQ feedback on a unique PUCCH, which can be implemented in a base station of FIG. 1A;

FIG. 4B is a flow diagram of an example method that includes configuring the same PUCCH for a plurality of UEs, enabling each of the UEs to transmit HARQ feedback on the same PUCCH, which can be implemented in a base station of FIG. 1A;

FIG. 5A is a flow diagram of an example method that includes configuring first and second PUCCHs for a UE to transmit HARQ feedback on the first and second PUCCHs if the UE fails to receive respective first and second MBS data packets, which can be implemented in a base station of FIG. 1A;

FIG. 5B is a flow diagram of an example method that includes configuring a common PUCCH for a UE to transmit HARQ feedback on the common PUCCH if the UE fails to receive first and second MBS data packets, which can be implemented in a base station of FIG. 1A;

FIGS. 6-1 and 6-2 illustrate respective portions of a flow diagram of an example method that includes preparing HARQ transmissions to transmit unicast data packets and/or MBS data packets to a UE, which can be implemented in a base station of FIG. 1A;

FIG. 7 is a flow diagram of an example method that includes preparing HARQ transmissions to transmit MBS data packets to a UE, which can be implemented in a base station of FIG. 1A;

FIG. 8 is a flow diagram of an example method that includes preparing a HARQ retransmission as a unicast retransmission carrying MBS data packets and/or non-MBS (i.e., unicast) data packets, which can be implemented in a base station of FIG. 1A;

FIG. 9 is a flow diagram of an example method that includes using two different MBS-RNTIs to receive MBS data packets for two different MBSs using a HARQ process, which can be implemented in a UE of FIG. 1A;

FIG. 10 is a flow diagram of an example method that includes switching from one MBS-RNTI to another different MBS-RNTI to receive MBS data packets for two different MBSs using a HARQ process, which can be implemented in a UE of FIG. 1A;

FIG. 11 is a flow diagram of an example method that includes receiving unicast data packets and/or MBS data packets from a RAN using a HARQ process, which can be implemented in a UE of FIG. 1A;

FIG. 12 is a flow diagram of an example method for providing an MBS, which can be implemented in a base station of FIGS. 1A or 1B; and

FIG. 13 is a flow diagram of an example method for receiving an MBS, which can be implemented in a UE of FIGS. 1A or 1B.

### DETAILED DESCRIPTION OF THE DRAWINGS

Generally speaking, the techniques of this disclosure allow UEs to reliably receive MBS information via radio resources allocated by a base station of a RAN by way of a HARQ process. In performing the HARQ process, the base station can multicast or broadcast (“multicast” or “broadcast” interchangeably referred to as “transmit”) a PDU (e.g., a MAC PDU) of an MBS data packet to one or multiple UEs on the downlink (DL), and the one or more multiple UEs can transmit (i.e., unicast) HARQ feedback (e.g., negative acknowledgement) to the base station on the uplink (UL) when the PDU of the MBS data packet was not successfully received. In response, the base station can retransmit the PDU of the MBS data packet(s). Throughout this disclosure, “MBS data packet” or “MBS packet” is interchangeably referred to as “PDU of the MBS data packet.” Similarly, “unicast data packet” is interchangeably referred to as “PDU of the unicast data packet.”

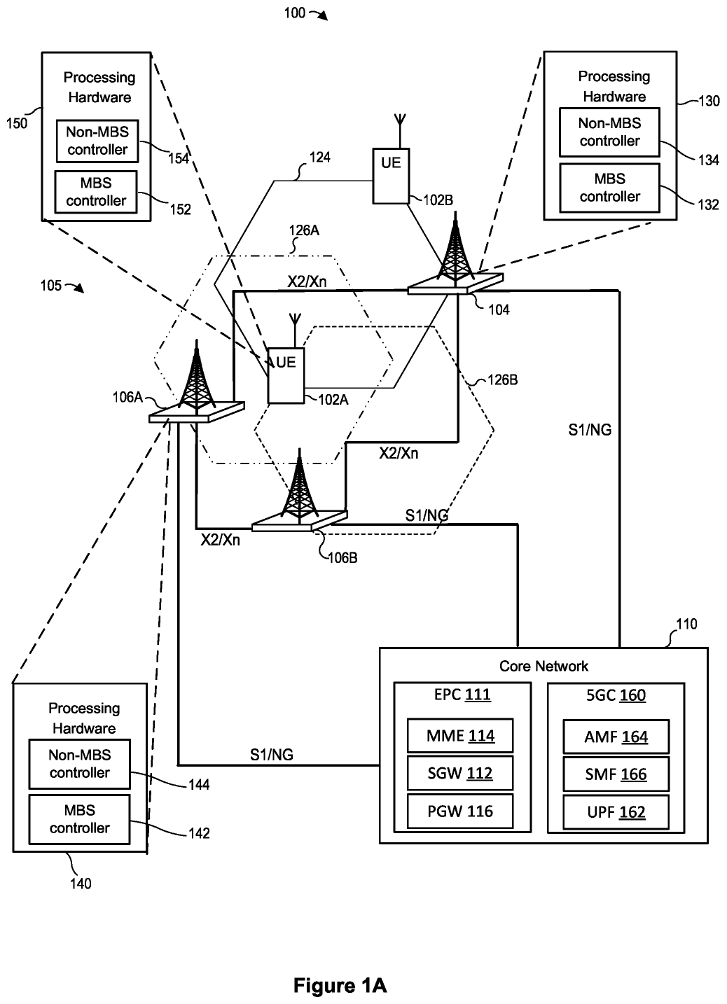

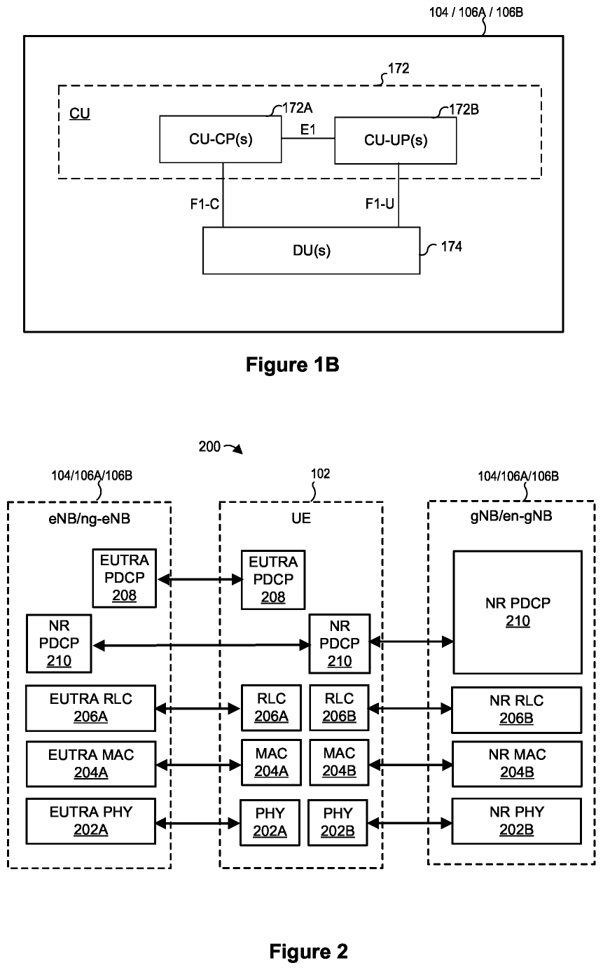

FIG. 1A depicts an example wireless communication system 100 that can implement HARQ-based MBS operation techniques of this disclosure. The wireless communication system 100 includes UE 102A and UE 102B, as well as base stations 104, 106A, 106B of a radio access network (RAN) (e.g., RAN 105) that are connected to a core network (CN) 110. To ease readability, UE 102 is used herein to represent the UE 102A, the UE 102B, or both the UE 102A and UE 102B, unless otherwise specified. The base stations 104, 106A, 106B can be any suitable type, or types, of base stations, such as an evolved node B (eNB), a next-generation eNB (ng-eNB), or a 5G Node B (gNB), for example. As a more specific example, the base station 104 can be an eNB or a gNB, and the base stations 106A and 106B can be gNBs.

The base station 104 supports a cell 124, the base station 106A supports a cell 126A, and the base station 106B supports a cell 126B. The cell 124 partially overlaps with both of cells 126A and 126B, such that the UE 102 can be in range to communicate with base station 104 while simultaneously being in range to communicate with base station 106A or 106B (or in range to detect or measure the signal from both base stations 106A and 106B). The overlap can make it possible for the UE 102 to hand over between cells (e.g., from cell 124 to cell 126A or 126B) or base stations (e.g., from base station 104 to base station 106A or base station 106B) before the UE 102 experiences radio link failure, for example. Moreover, the overlap allows the various dual connectivity (DC) scenarios discussed below. For example, the UE 102 can communicate in DC with the base station 104 (operating as an MN) and the base station 106A (operating as an SN) and, upon completing a handover to base station 106B, can communicate with the base station 106B (operating as an MN). As another example, the UE 102 can communicate in DC with the base station 104 (operating as an MN) and the base station 106A (operating as an SN) and, upon completing an SN change, can communicate with the base station 104 (operating as an MN) and the base station 106B (operating as an SN).

More particularly, when the UE 102 is in DC with the base station 104 and the base station 106A, the base station 104 operates as a master eNB (MeNB), a master ng-eNB (Mng-eNB), or a master gNB (MgNB), and the base station 106A operates as a secondary gNB (SgNB) or a secondary ng-eNB (Sng-eNB).

In non-MBS (i.e., unicast) operation, the UE 102 can use a radio bearer (e.g., a DRB or an SRB) that at different times terminates at an MN (e.g., the base station 104) or an SN (e.g., the base station 106A). For example, after handover or SN change to the base station 106B, the UE 102 can use a radio bearer (e.g., a DRB or an SRB) that at different times terminates at the base station 106B. The UE 102 can apply one or more security keys when communicating on the radio bearer, in the UL (from the UE 102 to a base station) and/or DL (from a base station to the UE 102) direction. In the non-MBS operation, the UE 102 transmits data via the radio bearer on (i.e., within) an UL bandwidth part (BWP) of a cell to the base station and/or receives data via the radio bearer on a DL BWP of the cell from the base station. The UL BWP can be an initial UL BWP or a dedicated UL BWP, and the DL BWP can be an initial DL BWP or a dedicated DL BWP. The UE 102 can receive paging, system information, public warning message(s) or a random access response on the DL BWP.

In MBS operation, the UE 102 can use a radio bearer (e.g., a DRB or an MBS radio bearer (MRB)) that at different times terminates at an MN (e.g., the base station 104) or an SN (e.g., the base station 106A). For example, after handover or SN change to the base station 106B, the UE 102 can use a radio bearer (e.g., a DRB or an MRB) that at different times terminates at the base station 106B which can be an MN or SN. In some implementations, the base station (e.g., the MN or SN) can transmit MBS data over dedicated radio resources (i.e., the radio resources dedicated to the UE 102) to the UE 102 (e.g., via the DRB or MRB). In such implementations, the base station can apply one or more security keys to protect integrity of MBS data and/or encrypt MBS data and transmits the encrypted and/or integrity protected MBS data over the dedicated radio resources to the UE 102. Correspondingly, the UE 102 can apply the one or more security keys to decrypt MBS data and/or check integrity of the MBS data when receiving the MBS data on the radio bearer, in the DL (from a base station to the UE 102) direction. In other implementations, the base station (e.g., the MN or SN) can transmit MBS data over common radio resources (i.e., the radio resources common to the UE 102 and other UE(s)) or a DL BWP of a cell from the base station to the UE 102 (e.g., via the DRB or MRB). The DL BWP can be an initial DL BWP, a dedicated DL BWP, or an MBS DL BWP (i.e., a DL BWP specific for MBS or not for unicast). In such implementations, the base station can apply no security key to MBS data and transmit the MBS data on the radio bearer. Correspondingly, the UE 102 can apply no security key to MBS data received on the radio bearer. Alternatively, the base station can apply common security key(s) (i.e., the security key(s) are common for UEs including the UE 102) to MBS data and transmit the MBS data on the radio bearer. The UE 102 can apply an application-level security key, received from the CN 110 or an MBS server, to MBS data received on the radio bearer.

In the non-MBS operation, the UE 102 can be in a connected state. Alternatively, the UE 102 can be in an idle or inactive state if the UE 102 supports small data transmission in the idle or inactive state. In the MBS operation, the UE 102 can be in a connected state, idle or inactive state.

The base station 104 includes processing hardware 130, which can include one or more general-purpose processors (e.g., central processing units (CPUs)) and a computer-readable memory storing machine-readable instructions executable on the one or more general-purpose processor(s), and/or special-purpose processing units. The processing hardware 130 in the example implementation in FIG. 1A includes a base station MBS controller 132 that is configured to manage or control transmission of MBS data packet(s) received from the CN 110 or an edge server. For example, the base station MBS controller 132 can be configured to support Radio Resource Control (RRC) configurations, procedures and messaging associated with MBS procedures, HARQ, and/or to support the necessary operations, as discussed below. The processing hardware 130 can include a base station non-MBS controller 134 configured to manage or control one or more RRC configurations and/or RRC procedures, HARQ, and/or to support the necessary operations when the base station 104 operates as an MN or SN during a non-MBS operation.

The base station 106A includes processing hardware 140, which can include one or more general-purpose processors (e.g., CPUs) and a computer-readable memory storing machine-readable instructions executable on the general-purpose processor(s), and/or special-purpose processing units. The processing hardware 140 in the example implementation of FIG. 1A includes a base station MBS controller 142 that is configured to manage or control transmission of MBS data packet(s) received from the CN 110 or an edge server. For example, the base station MBS controller 142 can be configured to support RRC configurations, procedures and messaging associated with MBS procedures, HARQ, and/or to support the necessary operations, as discussed below. The processing hardware 140 can include a base station non-MBS controller 144 configured to manage or control one or more RRC configurations and/or RRC procedures, HARQ, and/or to support the necessary operations when the base station 106A operates as an MN or SN during a non-MBS operation. While not shown in FIG. 1A, the base station 106B can include processing hardware similar to the processing hardware 130 of the base station 104 or the processing hardware 140 of the base station 106A.

The UE 102 includes processing hardware 150, which can include one or more general-purpose processors (e.g., CPUs) and a computer-readable memory storing machine-readable instructions executable on the general-purpose processor(s), and/or special-purpose processing units. The processing hardware 150 in the example implementation of FIG. 1A includes a UE MBS controller 152 that is configured to manage or control reception of MBS data packet(s). For example, the UE MBS controller 152 can be configured to support RRC configurations, procedures and messaging associated with MBS procedures, HARQ, and/or to support the necessary operations, as discussed below. The processing hardware 150 can include a UE non-MBS controller 154 configured to manage or control one or more RRC configurations and/or RRC procedures, HARQ, and/or to support the necessary operations in accordance with any of the implementations discussed below, when the UE 102 communicates with an MN and/or a SN during a non-MBS operation. The processing hardware 150 in the example implementation of FIG. 1A can also include a soft buffer (not shown) to store HARQ transmissions received from a base station.

The CN 110 can be an evolved packet core (EPC) 111 or a fifth-generation core (5 GC) 160, both of which are depicted in FIG. 1A. The base station 104 can be an eNB supporting an 51 interface for communicating with the EPC 111, an ng-eNB supporting an NG interface for communicating with the 5 GC 160, or a gNB that supports an NR radio interface as well as an NG interface for communicating with the 5 GC 160. The base station 106A can be an EUTRA-NR DC (EN-DC) gNB (en-gNB) with an Si interface to the EPC 111, an en-gNB that does not connect to the EPC 111, a gNB that supports the NR radio interface and an NG interface to the 5 GC 160, or a ng-eNB that supports an EUTRA radio interface and an NG interface to the 5 GC 160. To directly exchange messages with each other during the scenarios discussed below, the base stations 104, 106A, and 106B can support an X2 or Xn interface.

Among other components, the EPC 111 can include a Serving Gateway (S-GW) 112, a Mobility Management Entity (MME) 114, and a Packet Data Network Gateway (P-GW) 116. The S-GW 112 is generally configured to transfer user-plane packets related to audio calls, video calls, Internet traffic, etc., and the MME 114 is configured to manage authentication, registration, paging, and other related functions. The P-GW 116 provides connectivity from the UE to one or more external packet data networks, e.g., an Internet network and/or an Internet Protocol (IP) Multimedia Subsystem (IMS) network. The 5 GC 160 includes a User Plane Function (UPF) 162 and an Access and Mobility Management (AMF) 164, and/or Session Management Function (SMF) 166. The UPF 162 is generally configured to transfer user-plane packets related to audio calls, video calls, Internet traffic, etc., the AMF 164 is configured to manage authentication, registration, paging, and other related functions, and the SMF 166 is configured to manage PDU sessions. The UPF 162, AMF 164 and/or the SMF 166 can be configured to support MBS. For example, the SMF 166 can be configured to manage or control MBS transport, configure the UPF 162 and/or RAN 105 for MBS flows, and/or manage or configure MBS session(s) or PDU Session(s) for MBS for UE 102. The UPF 162 is configured to transfer MBS data packets to audio, video, Internet traffic, etc. to the RAN 105. The UPF 162 and/or SMF 166 can be configured for both unicast service and MBS, or for MBS only.

Generally, the wireless communication network 100 can include any suitable number of base stations supporting NR cells and/or EUTRA cells. More particularly, the EPC 111 or the 5 GC 160 can be connected to any suitable number of base stations supporting NR cells and/or EUTRA cells. Although the examples below refer specifically to specific CN types (EPC, 5 GC) and RAT types (5G NR and EUTRA), in general the techniques of this disclosure can also apply to other suitable radio access and/or core network technologies such as sixth generation (6G) radio access and/or 6G core network or 5G NR-6G DC, for example.

In different configurations or scenarios of the wireless communication system 100, the base station 104 can operate as an MeNB, an Mng-eNB, or an MgNB, the base station 106B can operate as an MeNB, an Mng-eNB, an MgNB, an SgNB, or an Sng-eNB, and the base station 106A can operate as an SgNB or an Sng-eNB. The UE 102 can communicate with the base station 104 and the base station 106A or 106B via the same radio access technology (RAT), such as EUTRA or NR, or via different RATs.

When the base station 104 is an MeNB and the base station 106A is an SgNB, the UE 102 can be in EN-DC with the MeNB 104 and the SgNB 106A. When the base station 104 is an Mng-eNB and the base station 106A is an SgNB, the UE 102 can be in next generation (NG) EUTRA-NR DC (NGEN-DC) with the Mng-eNB 104 and the SgNB 106A. When the base station 104 is an MgNB and the base station 106A is an SgNB, the UE 102 can be in NR-NR DC (NR-DC) with the MgNB 104 and the SgNB 106A. When the base station 104 is an MgNB and the base station 106A is a Sng-eNB, the UE 102 can be in NR-EUTRA DC (NE-DC) with the MgNB 104 and the Sng-eNB 106A.

FIG. 1B depicts an example, distributed implementation of any one or more of the base stations 104, 106A, 106B. In this implementation, the base station 104, 106A, or 106B includes a centralized unit (CU) 172 and one or more distributed units (DUs) 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include the processing hardware 130 or 140 of FIG. 1A.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a medium access control (MAC) controller configured to manage or control one or more MAC operations or procedures (e.g., a random access procedure), and a radio link control (RLC) controller configured to manage or control one or more RLC operations or procedures when the base station (e.g., base station 106A) operates as an MN or an SN. The process hardware can also include a physical layer controller configured to manage or control one or more physical layer operations or procedures.

In some implementations, the CU 172 can include a logical node CU-CP 172A that hosts the control plane part of the Packet Data Convergence Protocol (PDCP) protocol of the CU 172 and/or radio resource control (RRC) protocol of the CU 172. The CU 172 can also include logical node(s) CU-UP 172B that hosts the user plane part of the PDCP protocol and/or Service Data Adaptation Protocol (SDAP) protocol of the CU 172. The CU-CP 172A can transmit the non-MBS control information and MBS control information, and the CU-UP 172B can transmit the non-MBS data packets and MBS data packets, as described herein.

The CU-CP 172A can be connected to multiple CU-UP 172B through the E1 interface. The CU-CP 172A selects the appropriate CU-UP 172B for the requested services for the UE 102. In some implementations, a single CU-UP 172B can be connected to multiple CU-CP 172A through the E1 interface. The CU-CP 172A can be connected to one or more DU 174s through an F1-C interface. The CU-UP 172B can be connected to one or more DU 174 through the F1-U interface under the control of the same CU-CP 172A. In some implementations, one DU 174 can be connected to multiple CU-UP 172B under the control of the same CU-CP 172A. In such implementations, the connectivity between a CU-UP 172B and a DU 174 is established by the CU-CP 172A using Bearer Context Management functions.

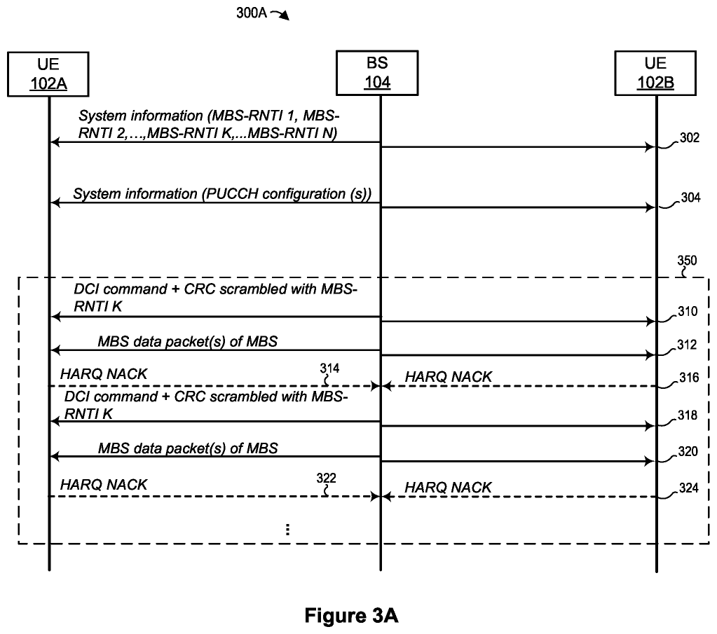

FIG. 2 illustrates, in a simplified manner, an example protocol stack 200 according to which the UE 102 can communicate with an eNB/ng-eNB or a gNB (e.g., one or more of the base stations 104, 106A, 106B).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to the EUTRA PDCP sublayer 208 and, in some cases, to the NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides RLC channels to the NR PDCP sublayer 210. The UE 102, in some implementations, supports both the EUTRA and the NR stack as shown in FIG. 2, to support handover between EUTRA and NR base stations and/or to support DC over EUTRA and NR interfaces. Further, as illustrated in FIG. 2, the UE 102 can support layering of NR PDCP 210 over EUTRA RLC 206A, and an SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets”. The packets can be MBS packets or non-MBS packets. For example, the MBS packets include MBS data packets including application content for an MBS service (e.g., IPv4/IPv6 multicast delivery, IPTV, software delivery over wireless, group communications, IoT applications, V2X applications, emergency messages related to public safety). In another example, the MBS packets include application control information for the MBS service.

On a control plane, the EUTRA PDCP sublayer 208 and the NR PDCP sublayer 210 can provide SRBs to exchange RRC messages or non-access-stratum (NAS) messages, for example. On a user plane, the EUTRA PDCP sublayer 208 and the NR PDCP sublayer 210 can provide DRBs to support data exchange. Data exchanged on the NR PDCP sublayer 210 can be SDAP PDUs, Internet Protocol (IP) packets or Ethernet packets.

In scenarios where the UE 102 operates in EN-DC with the base station 104 operating as an MeNB and the base station 106A operating as an SgNB, the wireless communication system 100 can provide the UE 102 with an MN-terminated bearer that uses EUTRA PDCP sublayer 208, or an MN-terminated bearer that uses NR PDCP sublayer 210. The wireless communication system 100 in various scenarios can also provide the UE 102 with an SN-terminated bearer, which uses only the NR PDCP sublayer 210. The MN-terminated bearer can be an MCG bearer, a split bearer, or an MN-terminated SCG bearer. The SN-terminated bearer can be an SCG bearer, a split bearer, or an SN-terminated MCG bearer. The MN-terminated bearer can be an SRB (e.g., SRB1 or SRB2), a DRB or a MRB. The SN-terminated bearer can be an SRB, a DRB or a MBS radio bearer (MRB).

In some implementations, a base station (e.g., base station 104, 106A or 106B) broadcasts MBS data packets via one or more MRBs, and in turn the UE 102 receives the MBS data packets via the MRB(s). The base station can include configuration(s) of the MRB(s) in MBS configuration parameters described below. In some implementations, the base station transmits the MBS data packets via RLC sublayer 206, MAC sublayer 204, and PHY sublayer 202, and correspondingly, the UE 102 uses PHY sublayer 202, MAC sublayer 204, and RLC sublayer 206 to receive the MBS data packets. In such implementations, the base station and the UE 102 may not use PDCP sublayer 208 and a SDAP sublayer 212 to communicate the MBS data packets. In other implementations, the base station transmits the MBS data packets via PDCP sublayer 208, RLC sublayer 206, MAC sublayer 204, and PHY sublayer 202, and correspondingly, the UE 102 uses PHY sublayer 202, MAC sublayer 204, RLC sublayer 206 and PDCP sublayer 208 to receive the MBS data packets. In such implementations, the base station and the UE 102 may not use a SDAP sublayer 212 to communicate the MBS data packets. In yet other implementations, the base station broadcasts the MBS data packets via the SDAP sublayer 212, PDCP sublayer 208, RLC sublayer 206, MAC sublayer 204 and PHY sublayer 202, and correspondingly, the UE 102 uses PHY sublayer 202, MAC sublayer 204, RLC sublayer 206, PDCP sublayer 208, and the SDAP sublayer 212 to receive the MBS data packets.

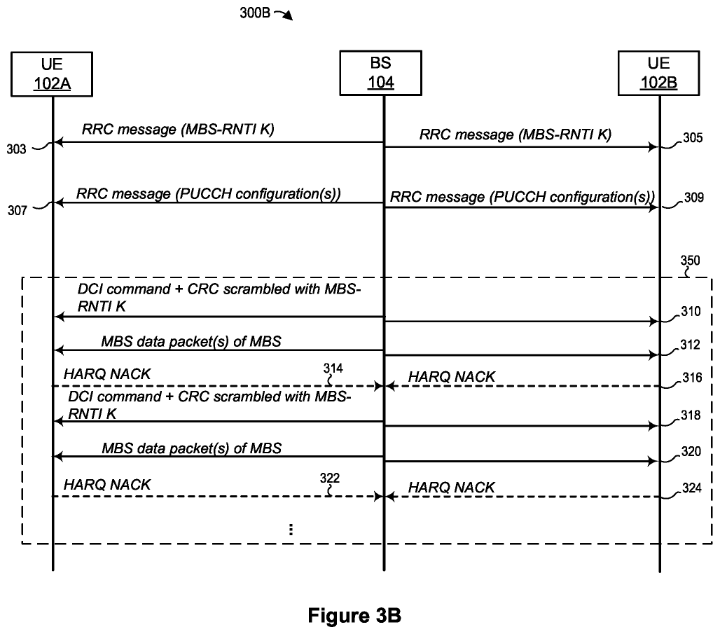

Now referring to a scenario 300A illustrated in FIG. 3A, the UE 102 (i.e., UE 102A and UE 102B) initially operates in connected state (e.g., RRC CONNECTED state), or more generally in a state in which there is an active radio connection between the UE 102 and the base station 104. Generally, the base station 104 provides to the UE 102 a configuration of resources for (i) receiving MBS data packet(s) in a downlink direction from the base station 104 and (ii) transmitting an indication of whether the UE 102 successfully received the MBS data packet(s) in an uplink direction to the base station 104.

Base station (BS) 104 transmits (i.e., multicast or broadcast) 302 system information including MBS radio network temporary identifiers (MBS-RNTIs) to the UE 102 on cell 124. The base station 104 transmits the MBS-RNTIs to the UE 102 at event 302 so that later on, when the base station 104 transmits MBS data packet(s) during a HARQ process, the UE 102 can use at least one of the MBS-RNTIs for decoding purposes to successfully receive the MBS data packet(s). The MBS RNTIs can include MBS-RNTIs 1, 2, . . . , K, . . . N, where K and N are integers and 0<K≤N. For example, N can be 16, 32, 64 or 128. In some implementations, each of the MBS-RNTIs is different than a cell RNTI (C-RNTI) that the base station 104 can use for unicast communication with the UE 102. In some implementations, each of the MBS-RNTIs can be a group RNTI (G-RNTI), a multicast RNTI (M-RNTI), or a single cell RNTI (SC-RNTI).

In some implementations, the base station 104 can assign each of the MBS-RNTIs for one or more particular MBSs (e.g., a first MBS, a second MBS, a third MBS, etc.). For example, the one or more MBSs can be for a respective application (e.g., the first MBS is for IPTV, the second MBS is for emergency message delivery, and the third MBS is for a V2X application). As another example, the one or more MBSs can for a single application (e.g., the first MBS is for a first channel of IPTV), the second MBS is for a second channel of IPTV, and the third MBS is for a third channel of IPTV. In some implementations, the base station 104 associates a particular MBS to only one particular MBS-RNTI (e.g., a first MBS is associated to only MBS-RNTI K). In other implementations, the base station 104 can associate a particular MBS to more than one MBS-RNTI (e.g., a first MBS is associated to MBS-RNTI K and MBS-RNTI L).

The base station 104 transmits 304 system information including one or more physical uplink control channel (PUCCH) configurations to the UE 102 on cell 124. In some implementations, the base station 104 can transmit 304 PUCCH configuration(s) at the same or different time instances as the MBS-RNTIs of event 302. In some implementations, the base station 104 can transmit 302, 304 the MBS-RNTIs and PUCCH configuration(s) periodically. In some implementations, each of the PUCCH configuration(s) can configure, or indicate for the UE 102 one or more PUCCH resources which includes at least one of the following configuration parameters: starting physical resource block (PRB) and/or PRB offset, intra-slot frequency hopping, second-Hop PRB, first symbol (i.e., starting symbol), number of symbols, initial cyclic shift index, number of PRBs, time-domain orthogonal cover code (OCC), OCC length, OCC index, inter-slot frequency hopping, a maximum code rate, number of slots, a modulation and coding scheme, PUCCH format(s), and PUCCH power control. In some implementations, each of the PUCCH configuration(s) is an information element (IE) that is different than a PUCCH-ConfigCommon IE that the base station 104 can broadcast in a System Information Block Type 1 (SIB1) on the cell 124. The base station 104 provides the PUCCH configuration(s) to the UE 102 at event 304 so that later on, if the UE 102 fails to successfully receive MBS data packet(s) from the base station 104, the UE 102 can consequently notify the base station 104 on a PUCCH corresponding to at least one of the PUCCH configuration(s) pursuant to the HARQ process.

In some implementations, the system information of events 302 and 304 can be the same system information, e.g., the same system information block (SIB). In other implementations, the system information of events 302 and 304 can be different system information, e.g., different SIBs. The base station 104 can transmit 302, 304 the system information in any order.

In some implementations, the base station 104 can assign a specific PUCCH configuration for each of the MBS-RNTIs. That is, each MBS-RNTI is associated to a specific PUCCH configuration. In other implementations, the base station 104 can assign a single PUCCH configuration for all of the MBS-RNTIs. In yet other implementations, the base station 104 can assign a first PUCCH configuration for a first group of MBS-RNTIs (e.g., MBS-RNTI 1, MBS-RNTI 2), a second PUCCH configuration for a second group of MBS-RNTIs (e.g., MBS-RNTI 3, MBS-RNTI 4, . . . MBS-RNTI K), . . . an X-th PUCCH configuration for an X-th group of MBS RNTIs (e.g., MBS-RNTI K+1, . . . MBS-RNTI N), where each group has one or more different MBS-RNTIs.

After broadcasting 302, 304 the system information, the base station 104 obtains MBS data packet(s) (e.g., of a first MBS) and prepares to transmit, to the UE 102, the MBS data packet(s) in a HARQ transmission pursuant to the HARQ process. Because the UE 102 may not be aware of any HARQ process information to successfully receive the HARQ transmission from the base station 104, the base station 104 transmits 310 such HARQ process information to the UE 102 before transmitting the MBS data packet(s). In some implementations, the base station 104 generates a DCI command which assigns a downlink resource, such as a physical downlink shared channel (PDSCH), so that the base station 104 can transmit the MBS data packet(s) to the UE 102 on the PDSCH. In these implementations, the base station 104 can generate a cyclic redundancy check (CRC) for the DCI command and scramble the CRC with any one of the MBS-RNTI (e.g., MBS-RNTI K) transmitted to the UE 102 at event 302 to obtain a scrambled CRC. As described herein with respect to FIG. 3A, the particular MBS-RNTI can be MBS-RNTI K, but it should be understood that the particular MBS-RNTI can be any one of the MBS RNTIs described in event 302. The base station 104 can transmit 310 the DCI command and the CRC scrambled with the MBS-RNTI K to the UE 102 on a physical downlink control channel (PDCCH). The scrambled CRC can be upended to or otherwise associated with the DCI command, in some implementations. The UE 102 de-scrambles the received scrambled CRC using the MBS-RNTI (e.g., MBS-RNTI K) received at event 302, so that the UE 102 can recognize (and be aware of) the PDSCH assigned by the DCI command on which the base station 104 will transmit MBS data packet(s).

After transmitting 310 the DCI command and the scrambled CRC, the base station 104 transmits 312 the MBS data packet(s) in a HARQ transmission pursuant to the HARQ process on the PDSCH. If the UE 102 successfully receives the MBS data packet(s)) at event 312, the UE 102 in some implementations can transmit a HARQ acknowledgement (ACK) to the base station 104. In other implementations, the UE 102 need not transmit the HARQ ACK.

However, e.g., in poor signal conditions, the UE 102 may not successfully receive the MBS data packet(s) at event 312. Accordingly, pursuant to the HARQ process, the UE 102 transmits 314 a HARQ negative acknowledgement (NACK) to the base station 104. The UE 102 may transmit 314 the HARQ NACK on a PUCCH determined from the PUCCH configuration(s) received at event 304. If the UE 102 received multiple PUCCH configurations at event 304, the UE 102 in some implementations identifies a specific PUCCH configuration associated to the MBS-RNTI K and determines the PUCCH in accordance with the specific PUCCH configuration.

In some implementations, the PUCCH determined by the UE 102A and UE 102B can be the same if the UE 102A and the UE 102B received the same PUCCH configuration(s) from the base station 104 at event 304. Therefore, and in contrast to scenarios in which the UE 102 (i.e., each of the UE 102A and 102B) may be assigned unique UL radio resources (time/frequency) to transmit HARQ feedback in response to successfully receiving (or not successfully receiving) unicast data packet(s), each of the UE 102A and 102B is assigned same UL radio resources (time/frequency) to transmit HARQ feedback in response to successfully receiving (or not successfully receiving) MBS data packet(s). Accordingly, when each of the UE 102A and 102B transmits 314, 316 the HARQ NACK to the base station on the same PUCCH, the base station 104 may not be able to identify which specific UE 102 (i.e., UE 102A or UE 102B) provided the HARQ NACK. Nevertheless, because the base station 104 is at least aware that at least one of the UE 102 (e.g., UE 102A or UE 102B) did not successfully receive the MBS data packet(s) at event 312, the base station 104 can later retransmit the MBS data packet(s) to the UE 102 (i.e., UE 102A and UE 102B).

The manner in which the UE 102 determines when to send the HARQ NACK on the PUCCH can vary. In some implementations, the base station 104 includes a timing indicator in the DCI command at event 310. From the timing indicator, the UE 102 can determine slot(s) or symbol(s) on which to transmit the HARQ NACK. In other implementations where the base station 104 does not include a timing indicator in the DCI command, the UE 102 can determine when to send the HARQ NACK on the PUCCH according to the PUCCH configuration(s) received at event 304. For example, each of the PUCCH configuration(s) can include time-domain configuration parameters configuring occurrences of PUCCH resources, or timing for a PDSCH (where a MBS data packet is transmitted) to an uplink HARQ NACK.

In response to receiving the HARQ NACK at events 314, 316 from the UE 102, the base station 104 can transmit 318 a DCI command and scrambled CRC to the UE 102, similar to event 310, and subsequently retransmit 320 MBS data packet(s) to the UE 102 on a PDSCH assigned by the DCI command in a HARQ retransmission pursuant to the HARQ process. The base station 104 can generate the HARQ retransmission of event 320 as having the same redundancy version (RV) or different RVs as the HARQ transmission of event 312.

If the UE 102 still does not successfully receive the MBS data packet(s) at event 320, the base station 104 can receive 322, 324 a HARQ NACK from the UE 102, similar to events 314, 316.

As described above, during the HARQ process, the base station 104 transmits a DCI command at event 310 prior to a HARQ transmission at event 312, and another DCI command at event 318 prior to a HARQ retransmission at event 320 if the UE 102 transmits a HARQ NACK at either of events 314, 316. To assist the UE 102 in determining whether the DCI command is for a HARQ transmission (i.e., a new HARQ transmission that has not been previously transmitted to the UE 102) or a HARQ retransmission, the base station 104 can include a new indicator (NDI) field in the DCI command to specify whether the DCI command is for a new HARQ transmission or a HARQ retransmission. Consequently, based on the NDI of the DCI command, the UE 102 can determine whether the HARQ transmission at events 312, 320 is a new HARQ transmission or a HARQ retransmission.

In some implementations, the base station 104 can set the NDI of a DCI command (e.g., the DCI command of event 310) to a first static default value (e.g., either a 0 or 1 as specified in a 3GPP specification) indicating that the HARQ transmission is a new HARQ transmission. Similarly, the base station 104 can set the NDI of a DCI command (e.g., the DCI command of event 318) to a second static default value (e.g., 1 if the first static default value is 0, 0 if the first static default value is 1, or the same value as the first static default value) indicating that the HARQ transmission is a HARQ retransmission of a previous HARQ transmission.

In other implementations, rather than using particular static NDI values to designate a HARQ transmission as a new HARQ transmission or a HARQ retransmission, the base station 104 can toggle (or not toggle) the NDI value to indicate whether the HARQ transmission is a new HARQ transmission or a HARQ retransmission. For example, the base station 104 can set the NDI of a DCI command (e.g., the DCI command of event 310) to an initial value (e.g., 0, 1) indicating that the HARQ transmission is a new HARQ transmission. Similarly, the base station 104 can set the NDI of a DCI command (e.g., the DCI command of event 318) to a toggled value (e.g., 1 if the initial value is 0, 0 if the initial value is 1) indicating that the HARQ transmission is a HARQ retransmission. Alternatively, the base station 104 can maintain the NDI of a DCI command (e.g., the DCI command of event 318) in its non-toggled state (e.g., 1 if the initial value is 1, 0 if the initial value is 0) indicating that the HARQ transmission is a HARQ retransmission. In this example, the base station 104 can toggle the NDI value to indicate additional new HARQ transmissions.

In some scenarios, if the base station 104 does not receive a HARQ NACK from the UE 102 at event 314, the base station 104 can transmit 318 a DCI command and a CRC scrambled with the MBS-RNTI K to the UE 102, similar to event 310, to transmit 320 new MBS data packet(s) in a new HARQ transmission, similar to event 312. In these scenarios, the base station 104 can set the NDI of the DCI command at event 318 to the first static default value described above, indicating that the HARQ transmission is a new HARQ transmission. In another implementation, the base station 104 can toggle the NDI value, relative to the NDI in the DCI command at event 310, to indicate that the HARQ transmission is a new transmission.

In response to receiving a DCI command and determining that the HARQ transmission is a new transmission according to the NDI included in the DCI command, the UE 102 can flush a soft buffer and store the HARQ transmission in the soft buffer. In response to determining that the HARQ transmission is a HARQ retransmission of a previous HARQ transmission according to the NDI included in the DCI command, the UE 102 can combine (i.e., HARQ combine) the HARQ transmission and the HARQ retransmission and decode the combined HARQ transmissions pursuant to the HARQ process.

Events 310, 312, 314, 316, 318, 320, 322 and 324 are collectively referred to as an MBS transmission procedure 350. In some implementations, the base station 104 can perform multiple MBS transmission procedures, each similar to MBS transmission procedure 350, in parallel or one after another by using different MBS-RNTIs. In some implementations, the base station 104 can perform multiple MBS transmission procedures for respective multiple MBSs (e.g., a first MBS, a second MBS, a third MBS, etc.) to transmit MBS data packets of the respective MBSs on respective PDSCHs using respective MBS-RNTIs on the cell 124. To schedule the respective PDSCHs on different frequency resources (e.g., physical resource blocks (PRBs)) and/or different time instances (e.g., slots or symbols), the base station 104 can transmit multiple DCI commands with CRCs scrambled by different MBS-RNTIs. For example, in addition to performing the MBS transmission procedure 350 using MBS-RNTI K to transmit MBS data packet(s) (e.g., of a first MBS), the base station 104 can perform a second MBS transmission procedure by transmitting second DCI command(s) and second CRC(s) scrambled with a second MBS-RNTI (e.g., MBS-RNTI L) on PDCCH(s) to schedule second PDSCH(s) including MBS data packet(s) (e.g., of a second MBS). Then the base station 104 can transmit the MBS data packet(s) in a HARQ transmission pursuant to the HARQ process on the second PDSCH(s). In other implementations, the base station 104 can perform multiple MBS transmission procedures for a single MBS to transmit MBS data packets of the single MBS on respective PDSCHs using respective MBS-RNTIs on the cell 124. To schedule the respective PDSCHs on different frequency resources (e.g., physical resource blocks (PRBs)) and/or different time instances (e.g., slots or symbols), the base station 104 can transmit multiple DCI commands with CRCs scrambled by different MBS-RNTIs. For example, in addition to performing the MBS transmission procedure 350 using MBS-RNTI K to transmit first MBS data packet(s) (e.g., of a first MBS), the base station 104 can perform a second MBS transmission procedure by transmitting second DCI command(s) and second CRC(s) scrambled with a second MBS-RNTI (e.g., MBS-RNTI L) on PDCCH(s) to schedule second PDSCH(s) including second MBS data packet(s) (e.g., of the first MBS). Then the base station 104 can transmit the second MBS data packet(s) in a HARQ transmission pursuant to the HARQ process on the second PDSCH(s). The UE 102 can process the first MBS data packet(s) and the second MBS data packet(s) jointly for the first MBS. For example, the first MBS data packet(s) can include voice packet(s) and the second MBS data packet(s) can include video packet(s). In another example, the first MBS data packet(s) can include packet(s) for basic video frame(s) and the second MBS data packet(s) can include packet(s) for enhancing the basic video frame(s) so that the UE 102 can use the first and second MBS data packet(s) to obtain high-resolution video frame(s).

In some implementations, the base station 104 may configure a particular MBS-RNTI not associated to a PUCCH configuration. In such implementations, the UE 102 receives PDSCH(s) including HARQ transmission(s) in accordance with the particular MBS-RNTI and does not transmit HARQ feedback for the HARQ transmission(s). The UE 102 receives HARQ transmission on PDSCHs in accordance with DCIs with CRCs scrambled with the particular MBS-RNTI. In some implementations, the base station 104 can set NDIs in the DCIs as described above by using automatic retransmission without HARQ feedback. In other implementations, the base station 104 does not transmit HARQ retransmissions. In this case, the base station 104 can set NDIs in the DCIs to the first default value or does not include an NDI in each of the DCIs.

Now referring to FIG. 3B, whereas the base station 104 of FIG. 3A multicasts or broadcasts MBS-RNTI K and PUCCH configuration(s) in the system information to the UE 102, the base station 104 of FIG. 3B transmits (i.e., unicasts) MBS-RNTI K and PUCCH configuration(s) in dedicated messages associated with a protocol for controlling radio resources (e.g., RRC messages) to the UE 102. Otherwise, any of the implementations described above in reference to FIG. 3A can be applied to scenario 300B of FIG. 3B.

Similar to scenario 300A, in scenario 300B, the UE 102 (i.e., UE 102A and UE 102B) initially operates in connected state (e.g., RRC_CONNECTED state), or more generally in a state in which there is an active radio connection between the UE 102 and the base station 104.

Base station 104 transmits 303 a first dedicated RRC message including the MBS-RNTI K to the UE 102A, and transmits 305 a second dedicated RRC message including the MBS-RNTI K to the UE 102B. Similarly, the base station 104 transmits 307 a third dedicated RRC message including the PUCCH configuration(s) to the UE 102A, and transmits 309 a fourth dedicated RRC message including the same PUCCH configuration(s) of event 307 to the UE 102B. In other implementations, the base station 104 can transmit the MBS-RNTI K and the PUCCH configuration(s) in the same dedicated RRC message (i.e., the first dedicated RRC message or the third dedicated RRC message) to the UE 102A. Similarly, the base station 104 can transmit the MBS-RNTI K and the PUCCH configuration(s) in the same dedicated RRC message (i.e., the second dedicated RRC message or the fourth dedicated RRC message) to the UE 102B. In some implementations, the base station 104 can include other MBS-RNTIs (e.g., MBS-RNTI L) in the first dedicated RRC message and the second dedicated RRC message. In yet other implementations, the base station 104 can transmit one or more RRC reconfiguration messages to the UE 102, to configure the other MBS-RNTIs. In some implementations, the base station 104 can configure the MBS-RNTIs (e.g., MBS-RNTI K, MBS-RNTI L) in response to a request or indication message from the UE 102, such as an UL RRC message (e.g., an MBS Interest Indication message), or in response to a request or indication message from the CN 110, such as a CN to BS interface message. The CN to BS interface message can be an NG application protocol message (e.g., a PDU Session Resource Setup Request message or PDU Session Resource Modify Request message).

In some implementations, each of the dedicated RRC messages described above can be a RRCSetup message, a RRCResume message, or a RRCReconfiguration message. The UE 102 can transmit a dedicated RRC response message in response to each of the dedicated RRC messages. The dedicated RRC response message can be a RRCSetupComplete message, a RRCResumeComplete message, or a RRCReconfigurationComplete message in response to the RRCSetup message, RRCResume message, or RRCReconfiguration message, respectively.

In some implementations, because the base station 104 transmits (i.e., unicasts) MBS-RNTI K and PUCCH configuration(s) in dedicated RRC messages to the UE 102, the base station 104 does not broadcast or multicast other MBS-RNTI(s) and other PUCCH configuration(s). In other implementations, the base station 104 still broadcasts or multicasts other MBS-RNTI(s) and other PUCCH configuration(s) to the UE 102, to enable the UE 102 to transmit HARQ NACK(s) for HARQ transmission(s) on PDSCH(s) scheduled by the other MBS-RNTI(s), as described in FIG. 3A.

In some implementations, in addition to transmitting a PUCCH configuration to the UE 102 for MBS communication using the MBS-RNTI K of the UE 102, the base station 104 can transmit to the UE 102 a second PUCCH configuration (e.g., PUCCH-Config IE or PUCCH-ConfigCommon IE) to the UE 102 for transmitting HARQ feedback to unicast communication during a HARQ process using a unique C-RNTI known by each respective UE 102 (i.e., UE 102A and UE 102B). Although the C-RNTI known by the UE 102A is different than the C-RNTI known by the UE 102B, the second PUCCH configuration transmitted to the UE 102A can be the same (or different from) the second PUCCH configuration transmitted to the UE 102B.

The base station 104 can perform a HARQ process for unicast communication similar to the manner in which the base station 104 performs a HARQ process for MBS communication. For instance, base station 104 generates a DCI command which assigns a PDSCH, so that the base station 104 can transmit unicast data packet(s) to the UE 102 on the PDSCH. The base station 104 generates a CRC for the DCI command and scrambles the CRC with a C-RNTI to obtain a scrambled CRC. The base station 104 can transmit the DCI command and the CRC scrambled with the C-RNTI to the UE 102 on a PDCCH. The UE 102 de-scrambles the received scrambled CRC using the C-RNTI known by the UE 102, so that the UE 102 can recognize (and be aware of) the PDSCH assigned by the DCI command on which the base station 104 will transmit unicast data packet(s). After transmitting the DCI command and the scrambled CRC, the base station 104 transmits the unicast data packet(s) in a HARQ transmission pursuant to the HARQ process on the PDSCH. If the UE 102 successfully receives the HARQ transmission, the UE 102 transmits a HARQ ACK on a PUCCH to the base station 104 in accordance with the second PUCCH configuration. Otherwise, the UE 102 transmits a HARQ NACK on the PUCCH.

The base station 104 can transmit the second PUCCH configuration to the UE 102 in various manners. In some implementations, the base station 104 can broadcast a SIB1 including the second PUCCH configuration on the cell 124. In other implementations, the base station 104 can include the second PUCCH configuration in one of more of the dedicated RRC message described above. For instance, the base station 104 can send an RRC reconfiguration message (e.g., RRCReconfiguration message) including the second PUCCH configuration to the UE 102. The UE 102 can transmit an RRC reconfiguration complete message (e.g., RRCReconfigurationComplete message) to the base station 104 in response to the RRC reconfiguration message.

In some implementations, the second PUCCH configuration for the unicast HARQ process can include one or more PUCCH resources that are the same as those included in the PUCCH configuration for the MBS HARQ process. In other implementations, none of the PUCCH resources included in the PUCCH configuration and the second PUCCH configuration are the same. In some implementations, the UE 102 is capable of a fixed number of HARQ processes (e.g., Z HARQ processes, e.g., Z=8, 16 or 32) for receiving both unicast and multicast/broadcast transmissions (i.e., HARQ transmissions). In some implementations, the base station 104 can configure the number of HARQ processes (e.g., X HARQ processes, X<2, 3, 4 . . . , or Z) that the UE 102 can use for receiving either unicast transmission or multicast/broadcast transmissions. Thus, the UE 102 refrains from using more than the configured number of HARQ processes to receive multicast/broadcast transmissions. In other implementations, the base station 104 does not configure the number of HARQ processes. Instead, the base station 104 derives the number of HARQ processes that the UE 102 is using to receive multicast/broadcast transmissions in accordance with the number of MBS-RNTIs (e.g., Y MBS-RNTIs, Y<Z) that the base station 104 configures to the UE 102, or information corresponding to/associated to the MBS-RNTIs. Therefore, the base station 104 derives that a remaining number of HARQ processes (e.g., Z-Y) that the UE 102 can use to receive unicast transmissions, in accordance with the number of HARQ processes for receiving multicast/broadcast transmissions. The base station 104 refrains from configuring the UE 102 to receive unicast transmissions using more than the remaining number of HARQ processes.

In other implementations, a pre-defined maximum number of HARQ processes for multicast/broadcast transmissions are specified in a 3GPP specification. The base station 104 refrains from configuring the UE 102 to receive multicast/broadcast transmissions using more than the pre-defined maximum number. The UE 102 also does not use more than the pre-defended maximum number of HARQ processes to receive multicast/broadcast transmissions. The UE 102 is capable of a fixed number of HARQ processes (e.g., Z HARQ processes, e.g., Z=8, 16 or 32) for receiving both unicast and multicast/broadcast transmissions (i.e., HARQ transmissions) or unicast transmissions only.

In yet other implementations, the UE 102 can send a UE capability indicating a maximum number of HARQ processes for multicast/broadcast transmissions to the base station 104, e.g., in a UE Capability Information message. Alternatively, the base station 104 can receive the UE capability from another base station (e.g., base station 106A, 106B) or the CN 110. The base station 104 refrains from configuring the UE 102 to receive multicast/broadcast transmissions using more than the pre-defined maximum number. The UE 102 also does not use more than the pre-defended maximum number of HARQ processes to receive multicast/broadcast transmissions.

In some implementations, the base station 104 can configure the UE 102 to send a HARQ ACK or not. For example, the base station 104 can enable or disable the UE 102 to transmit a HARQ ACK for indicating successful reception of a HARQ transmission including MBS data packet(s), by including a field or IE in the dedicated RRC message 303, 305, 307, 309 or in the second PUCCH configuration(s) 307, 309. Alternatively, if the base station 104 does not include the field or IE to disable transmitting a HARQ ACK in the dedicated RRC message, the UE 102 can transmit a HARQ ACK for the HARQ transmission. Yet alternatively, if the base station 104 does not include the field or IE to enable transmitting a HARQ ACK in the dedicated RRC message, the UE 102 refrains from transmitting a HARQ ACK for the HARQ transmission.

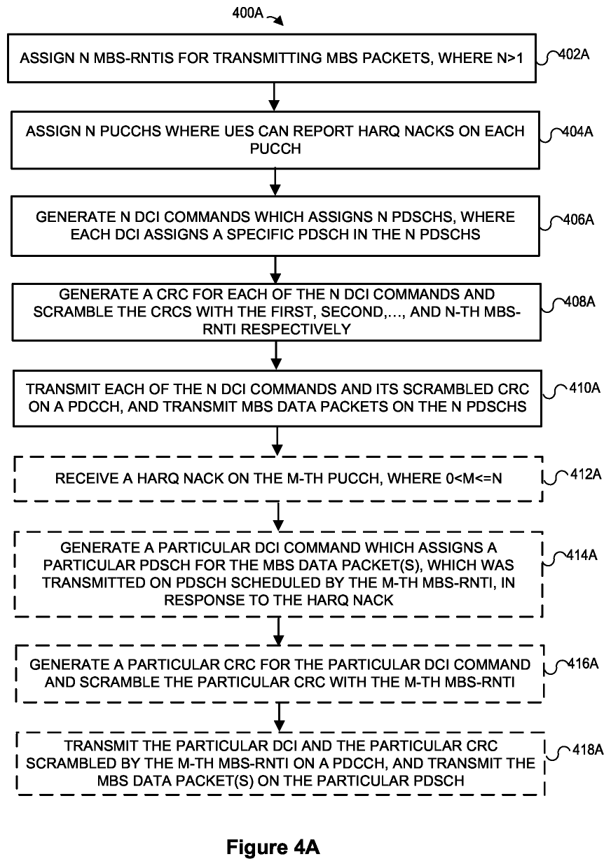

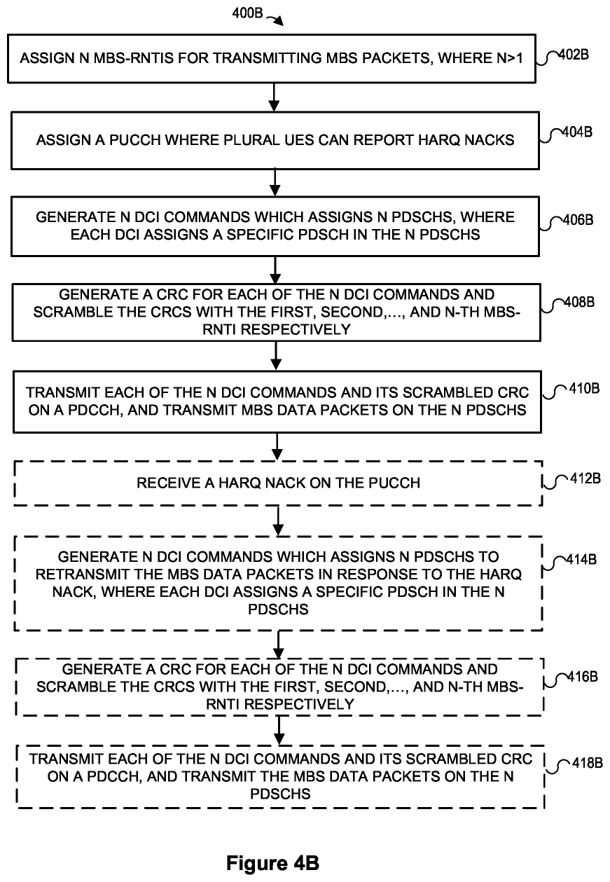

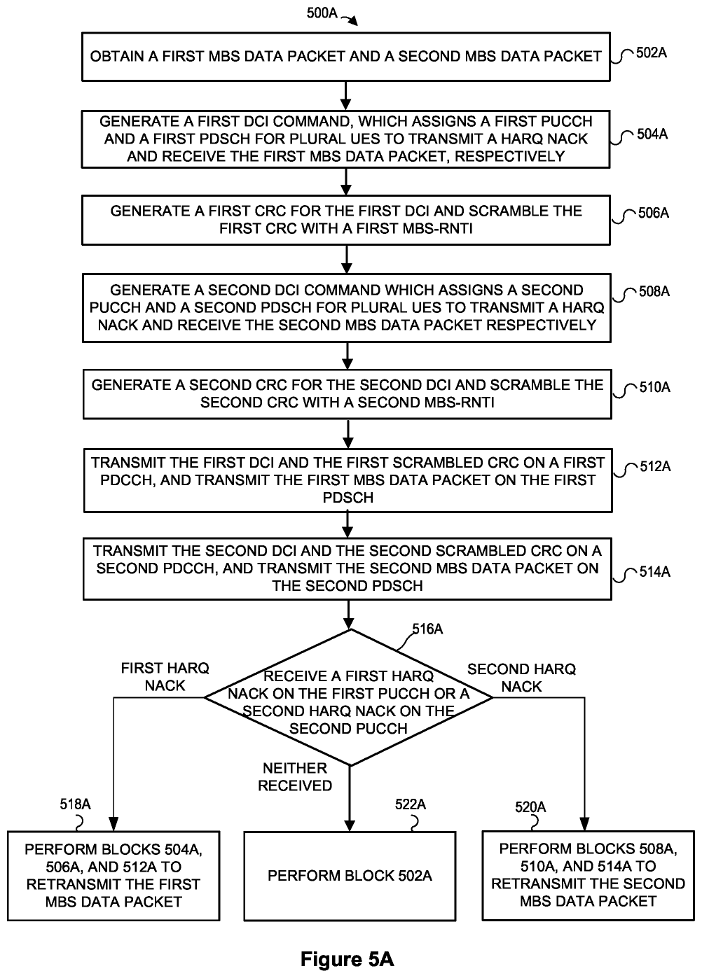

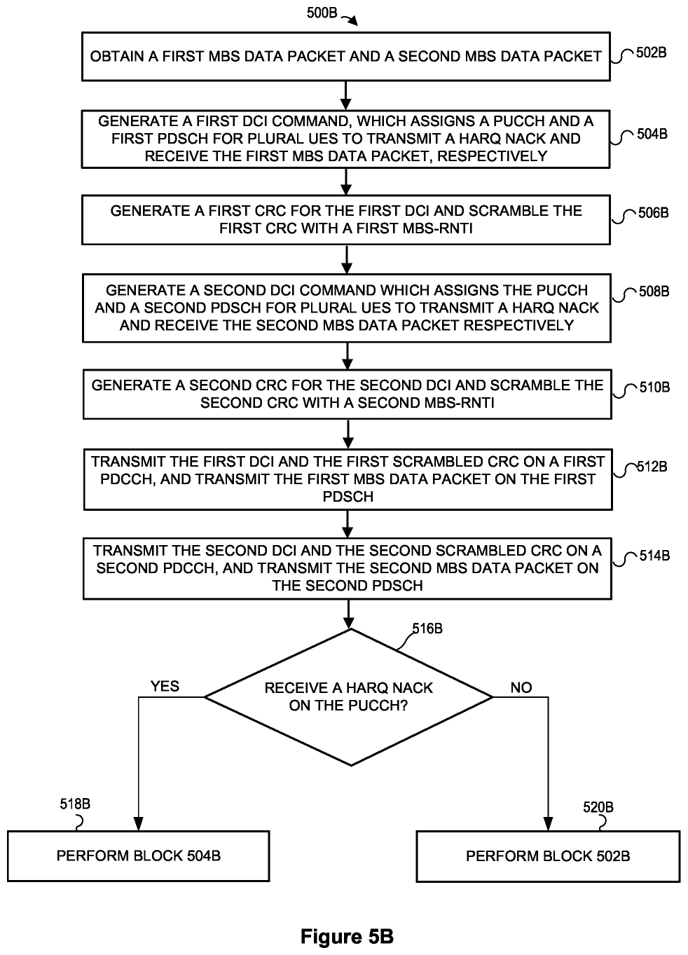

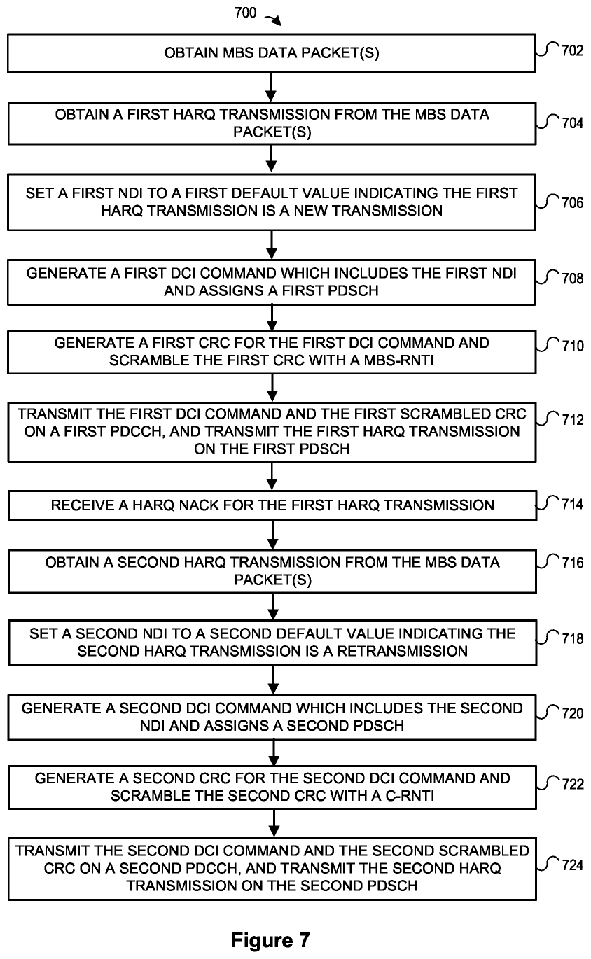

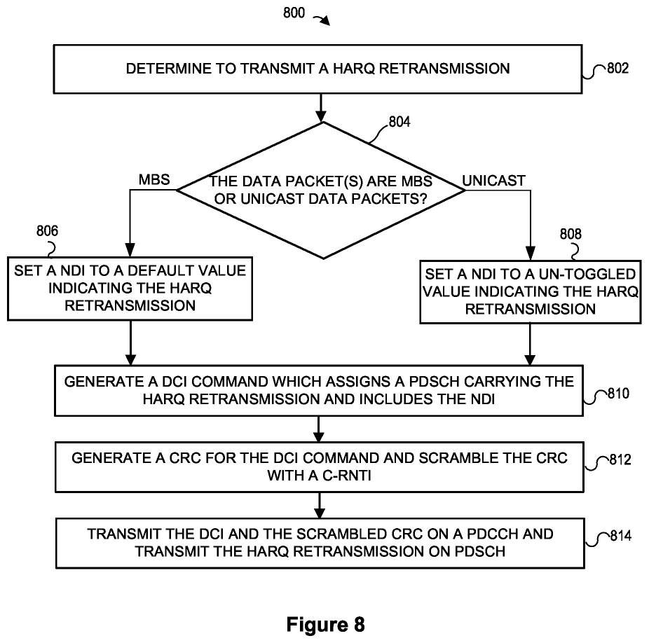

Now referring to FIGS. 4A-8, several example methods that the RAN 105 (e.g., base station 104) of this disclosure can implement are considered next. Each of these methods can be implemented using suitable processing hardware such as for example one or more processors configured to execute instructions stored on a non-transitory computer-readable medium. Particularly, in FIGS. 4A-4B, the base station 104 configures a common PUCCH for each UE 102 (e.g., UE 102A and UE 102B) or different PUCCHs for each UE 102, enabling each UE 102 to transmit HARQ feedback on the one or more PUCCHs. In FIGS. 5A-5B, the base station 104 configures a common PUCCH for each UE 102 to transmit HARQ feedback on when the UE 102 fails to receive MBS packets of either a first MBS or a second MBS, or different PUCCHs to transmit respective HARQ feedback on when the UE 102 fails to receive respective MBS packets of the first MBS or the second MBS. In FIGS. 6-1 and 6-2, the base station 104 prepares HARQ transmissions to transmit unicast data packets and/or MBS data packets to the UE 102. In FIG. 7, the base station 104 prepares HARQ retransmissions to transmit MBS data packets using a unicast RNTI. In FIG. 8, the base station 104 prepares HARQ retransmissions to transmit MBS data packets and/or non-MBS (i.e., unicast) data packets using a unicast RNTI.

Referring now to FIG. 4A, an example method 400A can be implemented in a base station (e.g., base station 104) for transmitting (i.e., multicasting or broadcasting) MBS information to a plurality of UEs (e.g., UE 102) using a HARQ process.

At block 402A, a base station assigns N MBS-RNTIs (i.e., MBS-RNTIs 1, 2, . . . N, where N is greater than 1) for transmitting MBS packets to the UE. The base station can assign each of the N MBS-RNTIs to respective MBSs (i.e., a first MBS, a second MBS, . . . an N-th MBS), so that the base station can transmit MBS packets (i.e., a first stream of MBS packets for the first MBS, a second stream of MBS packets for the second MBS, . . . an N-th stream of MBS packets for the N-th MBS) to the UE. The base station can transmit the N MBS-RNTIs to the UE (e.g., in event 302) so that the UE can use the N MBS-RNTIs to receive the MBS packets. In some implementations, the base station is aware of the MBS-RNTIs that the UE supports to receive MBSs according to a UE capability received from the UE. The UE can send a UE Capability Information message including the UE capability to the base station, e.g., in response to a UE Capability Enquiry message received from the base station. In other implementations, the base station can receive the UE capability from another base station (e.g., base station 106A or 106B) in a Handover Preparation procedure or Retrieve UE Context procedure. In yet other implementations, the base station can receive the UE capability from the CN 110 during the Initial Context Setup procedure or a Handover Preparation procedure.

At block 404A, the base station assigns the same number (i.e., N) of PUCCHs as MBS-RNTIs to the UE, so that the UE can report HARQ NACKs on respective N PUCCHs if the UE does not successfully receive the MBS data packets in HARQ transmissions. That is, the UE can report HARQ NACK on PUCCH 1 if the UE does not successfully receive the first stream of MBS packets for the first MBS, HARQ NACK on PUCCH 2 if the UE does not successfully receive the second stream of MBS packets for the second MBS, HARQ NACK on PUCCH N if the UE does not successfully receive the N-th stream of MBS packets for the N-th MBS. The N PUCCHs are all different from each other. That is, any two of the N PUCCHs use different PUCCH resources and/or uses the same PUCCH resources in different time instances. The base station can transmit N PUCCH configurations to the UE (e.g., in event 304) so that the UE is aware of the N PUCCHs for reporting HARQ NACKs if necessary.

At block 406A, the base station generates the same number (i.e., N) of DCI commands as MBS-RNTIs, where each of the N DCI commands assigns a respective N PDSCH on which the UE can receive the MBS data packets. That is, the base station generates DCI command 1 that assigns PDSCH 1 on which the UE can receive the first stream of MBS packets for the first MBS, DCI command 2 that assigns PDSCH 2 on which the UE can receive the second stream of MBS packets for the second MBS, . . . DCI command N that assigns PDSCH N on which the UE can receive the N-th stream of MBS packets for the N-th MBS.

At block 408A, the base station generates the same number (i.e., N) of CRCs for the respective N DCI commands, where each of the CRCs is scrambled with respective N MBS-RNTIs assigned at block 402A. That is, the base station generates CRC 1 scrambled with MBS-RNTI 1 for DCI command 1, CRC 2 scrambled with MBS-RNTI 2 for DCI command 2, . . . CRC N scrambled with MBS-RNTI N for DCI command N.

At block 410A, the base station transmits each of the N DCI commands and its scrambled respective N CRCs to the UE on a PDCCH (e.g., in event 310), as well as the MBS data packets on the N PDSCHs assigned at block 406A (e.g., in event 312). The UE can de-scramble the scrambled N CRCs using the respective N MBS-RNTIs received at block 402A, so that the UE can recognize (and be aware of) the respective N PDSCHs assigned by the respective N DCI commands on which the base station transmits the MBS data packets.

The UE may successfully receive one, some, or all of the MBS data packets in HARQ transmissions. For any MBS data packet(s) that the UE does not successfully receive from the base station, the UE can transmit a HARQ NACK to the base station, which in turn can retransmit the MBS data packet(s) the UE failed to receive in HARQ retransmissions. Because the base station assigned N PUCCHs for the UE to transmit the HARQ NACK at block 404A, the UE can transmit the HARQ NACK on a particular PUCCH among the N PUCCHs, depending on which MBS data packet(s) the UE failed to receive. For example, if the UE successfully received the first stream of MBS packets for the first MBS and the third stream of MBS packets for the third MBS, but failed to receive the second stream of MBS packets for the second MBS, the UE can transmit HARQ NACK on PUCCH 2. As such, the UE need not transmit HARQ NACKs on PUCCH 1 and PUCCH 3, and thus can save processing resources. Accordingly, at block 412A, if the UE did not successfully receive an M-th stream of MBS data packets for an M-th MBS, the base station receives a HARQ NACK from the UE on an M-th PUCCH, where 0<M≤N (e.g., in events 314, 316).

In response to receiving the HARQ NACK on the M-th PUCCH, the base station is aware that the UE failed to receive the M-th stream of MBS data packets for the M-th MBS. By identifying the M-th PUCCH (i.e., according to a PUCCH resource and/or a time instance of the M-th PUCCH), the base station can determine which HARQ transmission or particular PDSCH (e.g., M-th PDSCH) including the M-th stream of MBS data packets that the UE failed to receive. In response to the determination, the base station only retransmits the MBS packet(s) in a HARQ retransmission. The base station assumes that the UE successfully received the rest of the MBS data packets (e.g., the first stream of MBS packets for the first MBS, the third stream of MBS packets for the third MBS) if the base station did not receive other HARQ NACKs. Therefore, the base station need not generate all of the N DCI commands to retransmit only the M-th stream of MBS data packets via a HARQ retransmission. As such, at block 414A, the base station need only generate a particular DCI command (e.g., the M-th DCI command), which assigns a particular PDSCH (e.g., M-th PDSCH) for retransmitting the M-th stream of MBS data packets.

At block 416A, the base station generates a particular CRC (e.g., M-th CRC) for the particular DCI command, where the particular CRC is scrambled with a particular MBS-RNTI (e.g., M-th MBS-RNTI).

At block 418A, the base station transmits the particular DCI command and its scrambled particular CRC to the UE on a PDCCH (e.g., in event 318), as well as the M-th stream of MBS data packets in a HARQ retransmission on the particular PDSCH assigned at block 414A (e.g., in event 320). The UE can de-scramble the scrambled particular CRC using the particular MBS-RNTI, so that the UE can recognize (and be aware of) the particular PDSCH assigned by the particular DCI command on which the base station transmits the M-th stream of MBS data packets. The UE may successfully receive the M-th stream of MBS data packets on the particular PDSCH. If the UE does not successfully receive the M-th stream of MBS data packets, the UE can transmit a HARQ NACK to the base station (e.g., in events 322, 324).

Referring now to FIG. 4B, whereas the method 400A of FIG. 4A includes assigning N PUCCHs for a plurality of UEs to report HARQ NACKs, the method 400B of FIG. 4B includes assigning a single PUCCH for the plurality of UEs. Otherwise, any of the implementations described above in reference to FIG. 4A can be applied to method 400B of FIG. 4B.

At block 402B, a base station assigns N MBS-RNTIs (i.e., MBS-RNTIs 1, 2, . . . N, where N is greater than 1) for transmitting MBS packets to the UE, similar to block 402A.

At block 404B, the base station assigns a single PUCCH to the UE (i.e., the plurality of UEs), so that each UE can report HARQ NACKs on the same PUCCH if the UE does not successfully receive the MBS data packets in HARQ transmissions. That is, the UE can report HARQ NACK on PUCCH 1 if the UE does not successfully receive the first stream of MBS packets for the first MBS, HARQ NACK on PUCCH 1 if the UE does not successfully receive the second stream of MBS packets for the second MBS, HARQ NACK on PUCCH 1 if the UE does not successfully receive the N-th stream of MBS packets for the N-th MBS. The base station can transmit a PUCCH configuration to the UE (e.g., in event 304) so that the UE is aware of the PUCCH for reporting HARQ NACKs if necessary.

At block 406B, the base station generates the same number (i.e., N) of DCI commands as MBS-RNTIs, where each of the N DCI commands assigns a respective N PDSCH on which the UE can receive the MBS data packets, similar to block 406A.

At block 408B, the base station generates the same number (i.e., N) of CRCs for the respective N DCI commands, where each of the CRCs is scrambled with respective N MBS-RNTIs assigned at block 402B, similar to block 408A.

At block 410B, the base station transmits each of the N DCI commands and its scrambled respective N CRCs to the UE on a PDCCH (e.g., in event 310), as well as the MBS data packets on the N PDSCHs assigned at block 406B (e.g., in event 312), similar to block 410A. The UE can de-scramble the scrambled N CRCs using the respective N MBS-RNTIs received at block 402B, so that the UE can recognize (and be aware of) the respective N PDSCHs assigned by the respective N DCI commands on which the base station transmits the MBS data packets.

The UE may successfully receive one, some, or all of the MBS data packets in HARQ transmissions. For any MBS data packets that the UE does not successfully receive from the base station, the UE can transmit a HARQ NACK to the base station, which in turn can retransmit the MBS data packets the UE failed to receive in HARQ retransmissions. Because the base station assigned a single PUCCH for each UE to transmit the HARQ NACK at block 404B, the UE transmits the HARQ NACK on the single assigned PUCCH. Accordingly, at block 412B, if the UE did not successfully receive any of the MBS data packets from the base station, the base station receives a HARQ NACK from the UE on the single PUCCH (e.g., in events 314, 316).

In response to receiving the HARQ NACK on the single PUCCH, the base station is unaware which particular MBS (e.g., the first MBS, the second MBS, . . . the N-th MBS) the UE failed to receive, because the base station did not assign N PUCCHs for the UE to report HARQ NACKs on if the UE did not successfully receive the respective N MBSs. Thus, the base station at block 414B generates all of the N DCI commands to retransmit the MBS data packets of all N MBSs via a HARQ retransmission. The N DCI commands assign respective N PDSCHs for retransmitting the MBS data packets.

At block 416B, the base station generates N CRCs for the respective N DCI commands, where each of the CRCs is scrambled with respective N MBS-RNTIs assigned at block 402B.

At block 418B, the base station transmits each DCI command and its scrambled CRC to the UE on a PDCCH (e.g., in event 318), as well as the MBS data packets in a HARQ retransmission on the N PDSCHs assigned at block 414B (e.g., in event 320). The UE can de-scramble each scrambled CRC using the respective MBS-RNTI, so that the UE can recognize (and be aware of) the respective PDSCH assigned by the respective DCI command on which the base station transmits the MBS data packets. The UE may successfully receive the MBS data packets on each PDSCH. If the UE does not successfully receive any of the MBS data packets, the UE can transmit a HARQ NACK to the base station (e.g., in events 322, 324).

Referring now to FIG. 5A, an example method 500A can be implemented in a base station (e.g., base station 104) for transmitting (i.e., multicasting or broadcasting) MBS information of to at least two different MBSs (e.g., a first MBS and a second MBS) to a plurality of UEs (e.g., UE 102) using a HARQ process.

At block 502A, a base station obtains a first MBS data packet (e.g., of a first MBS) and a second MBS data packet (e.g., of a second MBS) and prepares to transmit, to the UE, the first MBS data packet and the second MBS data packet in a HARQ transmission pursuant to the HARQ process.

At block 504A, the base station generates a first DCI command, where the first DCI command assigns a first PDSCH on which the UE can receive the first MBS data packet, similar to block 406A. Additionally, the first DCI command assigns a first PUCCH on which the UE can report HARQ NACKs if the UE does not successfully receive the first MBS data packet in a HARQ transmission.

At block 506A, the base station generates a first CRC for the first DCI command, where the first CRC is scrambled with a first MBS-RNTI (e.g., MBS-RNTI K), similar to block 408A.

At block 508A, the base station generates a second DCI command, where the second DCI command assigns a second PDSCH on which the UE can receive the second MBS data packet, and a second PUCCH on which the UE can report HARQ NACKs if the UE does not successfully receive the second MBS data packet in a HARQ transmission, similar to block 504A.

At block 510A, the base station generates a second CRC for the second DCI command, where the second CRC is scrambled with a second MBS-RNTI (e.g., MBS-RNTI L), similar to block 506A.

At block 512A, the base station transmits the first DCI command and its scrambled first CRC to the UE on a PDCCH (e.g., in event 310), as well as the first MBS data packet on the first PDSCH (e.g., in event 312).

At block 514A, the base station transmits the second DCI command and its scrambled second CRC to the UE on a PDCCH (e.g., in event 310), as well as the second MBS data packet on the second PDSCH (e.g., in event 312), similar to block 512A.

The UE can de-scramble the scrambled first CRC and the scrambled second CRC using the respective first MBS-RNTI and the second MBS-RNTI, so that the UE can recognize (and be aware of) the respective first PDSCH and second PDSCH on which the base station transmits the respective first MBS data packet and the second MBS data packet.

The UE may successfully receive the first MBS data packet and/or the second MBS data packet in HARQ transmissions from the base station. If the UE does not successfully receive the first MBS data packet and/or the second MBS data packet from the base station, the UE can transmit a respective first HARQ NACK and/or second HARQ NACK on the respective first PUCCH and/or the second PUCCH to the base station, which in turn can retransmit the respective first MBS data packet and/or the second MBS data packet the UE failed to receive in HARQ retransmissions. If the UE successfully receives the first MBS data packet and the second MBS data packet from the base station, the UE need not transmit either of the first HARQ NACK or second HARQ NACK on the respective first PUCCH and second PUCCH to the base station. Thus, at block 516A, after determining whether the base station receives the first HARQ NACK on the first PUCCH and/or the second HARQ NACK on the second PUCCH, the base station can determine whether to retransmit the first MBS data packet and/or the second MBS data packet.

If the base station determines at block 516A to have received the first HARQ NACK on the first PUCCH from the UE (e.g., in events 314, 316), the base station is aware that the UE failed to receive the first MBS data packet. By identifying the first PUCCH, the base station can determine which HARQ transmission or first PDSCH including the first MBS data packet that the UE failed to receive. In response to the determination, the base station at block 518A proceeds to blocks 504A, 506A, and 512A to retransmit the first MBS packet in a HARQ retransmission (e.g., in events 318, 320). The base station assumes that the UE successfully received the second MBS data packet if the base station did not receive the second HARQ NACK. Therefore, the base station need not generate the second DCI command to retransmit only the first MBS data packet via a HARQ retransmission.

If the base station determines at block 516A to have received the second HARQ NACK on the second PUCCH from the UE (e.g., in events 314, 316), the base station is aware that the UE failed to receive the second MBS data packet. By identifying the second PUCCH, the base station can determine which HARQ transmission or second PDSCH including the second MBS data packet that the UE failed to receive. In response to the determination, the base station at block 520A proceeds to blocks 508A, 510A, and 514A to retransmit the second MBS packet in a HARQ retransmission (e.g., in events 318, 320). The base station assumes that the UE successfully received the first MBS data packet if the base station did not receive the first HARQ NACK. Therefore, the base station need not generate the first DCI command to retransmit only the second MBS data packet via a HARQ retransmission.

If the base station determines at block 516A to not have received either the first HARQ NACK or the second HARQ NACK, the base station is aware that the UE successfully received the first MBS data packet and second MBS data packet. In response to the determination, the base station at block 522A proceeds to block 502A to obtain new MBS data packets to transmit to the UE in a new HARQ transmission.

Referring now to FIG. 5B, whereas the method 500A of FIG. 5A includes assigning at least the first PUCCH and second PUCCH for a plurality of UEs to report HARQ NACKs, the method 500B of FIG. 5B includes assigning a single PUCCH for the plurality of UEs. Otherwise, any of the implementations described above in reference to FIG. 5A can be applied to method 500B of FIG. 5B.

At block 502B, a base station obtains a first MBS data packet (e.g., of a first MBS) and a second MBS data packet (e.g., of a second MBS) and prepares to transmit, to the UE, the first MBS data packet and the second MBS data packet in a HARQ transmission pursuant to the HARQ process, similar to block 502A.

At block 504B, the base station generates a first DCI command, where the first DCI command assigns a first PDSCH on which the UE can receive the first MBS data packet, and a PUCCH on which the UE can report HARQ NACKs if the UE does not successfully receive the first MBS data packet in a HARQ transmission, similar to block 504A.

At block 506B, the base station generates a first CRC for the first DCI command, where the first CRC is scrambled with a first MBS-RNTI (e.g., MBS-RNTI K), similar to block 506A.

At block 508B, the base station generates a second DCI command, where the second DCI command assigns a second PDSCH on which the UE can receive the second MBS data packet, and the same PUCCH assigned by the first DCI command (i.e., in contrast to a different, second PUCCH as described in block 508A) on which the UE can report HARQ NACKs if the UE does not successfully receive the second MBS data packet in a HARQ transmission.

At block 510B, the base station generates a second CRC for the second DCI command, where the second CRC is scrambled with a second MBS-RNTI (e.g., MBS-RNTI L), similar to block 510A.

At block 512B, the base station transmits the first DCI command and its scrambled first CRC to the UE on a PDCCH (e.g., in event 310), as well as the first MBS data packet on the first PDSCH (e.g., in event 312), similar to block 512A.

At block 514B, the base station transmits the second DCI command and its scrambled second CRC to the UE on a PDCCH (e.g., in event 310), as well as the second MBS data packet on the second PDSCH (e.g., in event 312), similar to block 514A.

The UE can de-scramble the scrambled first CRC and the scrambled second CRC using the respective first MBS-RNTI and the second MBS-RNTI, so that the UE can recognize (and be aware of) the respective first PDSCH and second PDSCH on which the base station transmits the respective first MBS data packet and the second MBS data packet.

The UE may successfully receive the first MBS data packet and/or the second MBS data packet in HARQ transmissions from the base station. If the UE does not successfully receive the first MBS data packet and/or the second MBS data packet from the base station, the UE can transmit a HARQ NACK on the PUCCH to the base station. Because the base station did not assign multiple PUCCHs at blocks 504B and 508B for the UE to report HARQ NACKs on if the UE did not successfully receive the respective first MBS data packet and the second MBS data packet, the base station is unaware which particular MBS data packet the UE failed to receive. Thus, in response to receiving a HARQ NACK on the PUCCH from the UE, the base station retransmits both the first MBS data packet and the second MBS data packet the UE failed to receive in HARQ retransmissions. If the UE successfully receives the first MBS data packet and the second MBS data packet from the base station, the UE need not transmit the HARQ NACK on the PUCCH to the base station. Thus, at block 516B, after determining whether the base station receives the HARQ NACK on the PUCCH, the base station can determine whether to retransmit the first MBS data packet and the second MBS data packet.

If the base station determines at block 516B to have received the HARQ NACK on the PUCCH from the UE (e.g., in events 314, 316), the base station at block 518A proceeds to blocks 504B to retransmit the first MBS packet and the second MBS packet in a HARQ retransmission (e.g., in events 318, 320).

If the base station determines at block 516B to not have received the HARQ NACK, the base station is aware that the UE successfully received the first MBS data packet and second MBS data packet. In response to the determination, the base station at block 520B proceeds to block 502B to obtain new MBS data packets to transmit to the UE in a new HARQ transmission.

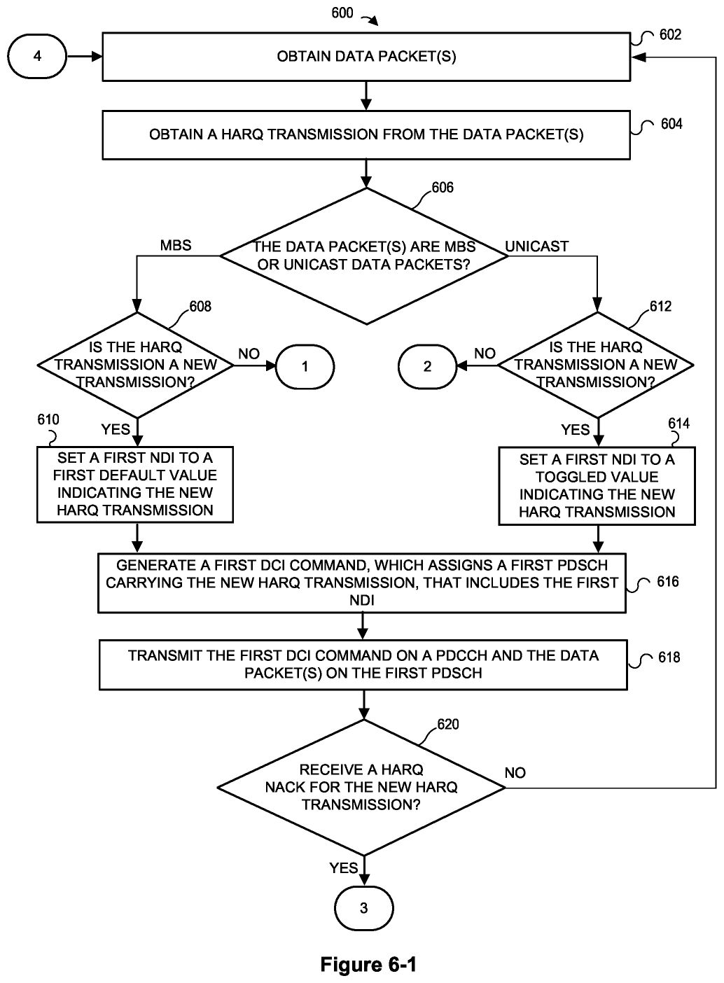

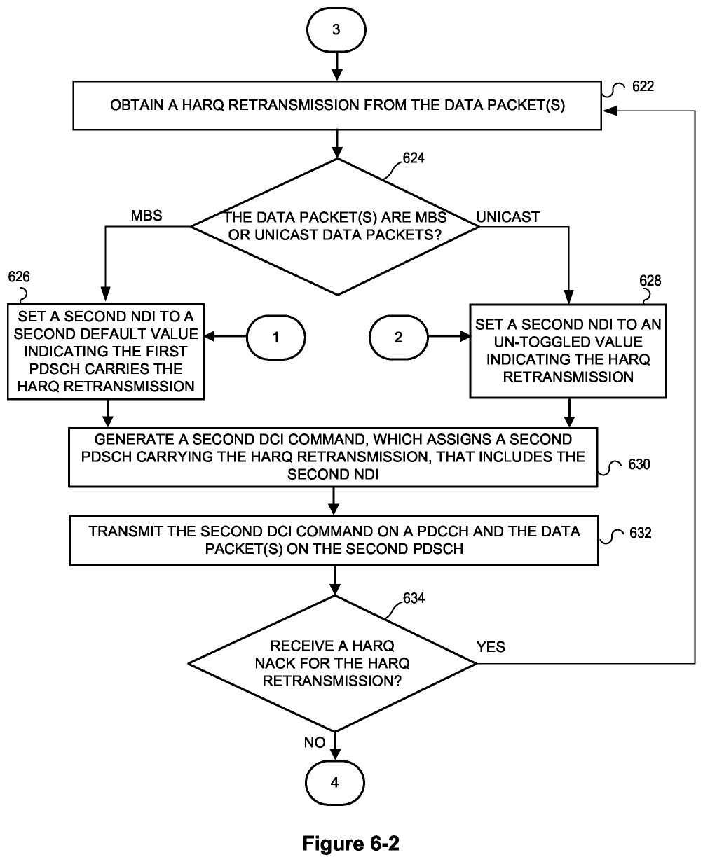

Referring now to FIG. 6-1, an example method 600 can be implemented in a base station (e.g., base station 104) for transmitting (i.e., multicasting or broadcasting) MBS information and/or non-MBS (i.e., unicast) information to a plurality of UEs (e.g., UE 102) using a HARQ process.

At block 602, a base station obtains data packet(s) and prepares to transmit, at block 604, the data packet(s) in a HARQ transmission to the UE pursuant to the HARQ process. The data packet(s) may be MBS data packet(s) and/or unicast data packet(s).

Generally, in the HARQ process, the base station generates a DCI command, where the DCI command assigns a PDSCH on which the UE can receive the data packet(s), and a PUCCH on which the UE can report HARQ NACK(s) if the UE does not successfully receive the data packet(s) in a HARQ transmission. To assist the UE in determining whether the DCI command is for a HARQ transmission (i.e., a new HARQ transmission that has not been previously transmitted to the UE) carrying MBS data packet(s) or unicast data packet(s), or a HARQ retransmission carrying MBS data packet(s) or unicast data packet(s), the base station can specify an NDI in the DCI command.

At block 606, the base station determines whether the data packet(s) to be transmitted in a HARQ transmission to the UE are MBS data packet(s) or unicast data packet(s). Alternatively, the base station at block 606 can determine whether to perform a HARQ process specifically for MBS. If the base station determines at block 606 that the data packet(s) are MBS data packet(s), or determines to perform a HARQ process specifically for MBS, the base station at block 608 determines whether the HARQ transmission is a new HARQ transmission or a HARQ retransmission.

If the base station at block 608 determines that the HARQ transmission is a new HARQ transmission, the base station at block 610 sets a first NDI to a first default value (e.g., 1 or 0) indicating the new HARQ transmission carrying the MBS data packet(s). Then the base station at block 616 generates a first DCI command including the first NDI set to the first default value. The first DCI command assigns a first PDSCH carrying the new HARQ transmission. The base station at block 618 transmits the first DCI command on a PDCCH and the MBS data packet(s) on the first PDSCH.

If the base station at block 620 does not receive a HARQ NACK from the UE (i.e., the UE successfully received the MBS data packet(s)), the base station proceeds to block 602 to obtain additional data packet(s). If the base station at block 620 receives a HARQ NACK from the UE, the base station at block 622 prepares to retransmit the MBS data packet(s) in a HARQ retransmission. Similar to block 606, the base station at block 624 determines that the data packet(s) for retransmission are MBS data packet(s), or determines to perform a HARQ process specifically for MBS. Then the base station at block 626 sets a second NDI to a second default value (e.g., 1 if the first NDI was set to 0, or 0 if the first NDI was set to 1) indicating the HARQ retransmission carrying the MBS data packet(s). Then the base station at block 630 generates a second DCI command including the second NDI set to the second default value. The second DCI command assigns a second PDSCH carrying the HARQ retransmission. The base station at block 632 transmits the second DCI command on a PDCCH and the MBS data packet(s) on the second PDSCH.

If the base station at block 634 does not receive a HARQ NACK from the UE (i.e., the UE successfully received the MBS data packet(s)), the base station proceeds to block 602 to obtain additional data packet(s). If the base station at block 634 receives a HARQ NACK from the UE, the base station at block 622 prepares to retransmit the MBS data packet(s) in another HARQ retransmission.

If the base station at block 608 determines that the HARQ transmission is a HARQ retransmission, the base station proceeds to block 1, illustrated in FIG. 6-2, and particularly blocks 626, 630, 632, and 634, as described above to retransmit the MBS data packet(s).

Referring back to block 606, if the base station determines that the data packet(s) are unicast data packet(s) instead of MBS data packet(s), or determines not to perform a HARQ process specifically for MBS, the base station at block 612 determines whether the HARQ transmission is a new HARQ transmission or a HARQ retransmission.

If the base station at block 612 determines that the HARQ transmission is a new HARQ transmission, the base station at block 614 sets a first NDI to a toggled value (e.g., 1 or 0) indicating the new HARQ transmission carrying the unicast data packet(s). Then the base station at block 616 generates a first DCI command including the first NDI set to the toggled value. The first DCI command assigns a first PDSCH carrying the new HARQ transmission. The base station at block 618 transmits the first DCI command on a PDCCH and the unicast data packet(s) on the first PDSCH.

If the base station at block 620 does not receive a HARQ NACK from the UE (i.e., the UE successfully received the unicast data packet(s)), the base station proceeds to block 602 to obtain additional data packet(s). If the base station at block 620 receives a HARQ NACK from the UE, the base station proceeds to block 3, illustrated in FIG. 6-2, and particularly at block 622 prepares to retransmit the unicast data packet(s) in a HARQ retransmission. Similar to block 606, the base station at block 624 determines that the data packet(s) for retransmission are unicast data packet(s), or determines not to perform a HARQ process specifically for MBS. Then the base station at block 628 sets a second NDI to an un-toggled value (e.g., 1 if the toggled value was set to 0, or 0 if the toggled value was set to 1) indicating the HARQ retransmission carrying the unicast data packet(s). Then the base station at block 630 generates a second DCI command including the second NDI set to the un-toggled value. The second DCI command assigns a second PDSCH carrying the HARQ retransmission. The base station at block 632 transmits the second DCI command on a PDCCH and the unicast data packet(s) on the second PDSCH.

If the base station at block 634 does not receive a HARQ NACK from the UE (i.e., the UE successfully received the unicast data packet(s)), the base station proceeds to block 4, illustrated in FIG. 6-1, and particularly block 602 to obtain additional data packet(s). If the base station at block 634 receives a HARQ NACK from the UE, the base station at block 622 prepares to retransmit the unicast data packet(s) in another HARQ retransmission.

If the base station at block 612 determines that the HARQ transmission is a HARQ retransmission, the base station proceeds to block 2, illustrated in FIG. 6-2, and particularly blocks 628, 630, 632, and 634, as described above to retransmit the unicast data packet(s).

Referring now to FIG. 7, an example method 700 can be implemented in a base station (e.g., base station 104) for transmitting (i.e., multicasting or broadcasting) MBS information to a plurality of UEs (e.g., UE 102) using a HARQ process.

At block 702, a base station obtains MBS data packet(s) and prepares to transmit, at block 704, the data packet(s) in a first HARQ transmission to the UE pursuant to the HARQ process.

To indicate to the UE whether the first HARQ transmission is a new HARQ transmission that has not been previously transmitted to the UE carrying MBS data packet(s) or a HARQ retransmission carrying MBS data packet(s), the base station can specify an NDI in a DCI command. At block 706, the base station determines to transmit the first HARQ transmission is a new HARQ transmission, and accordingly sets a first NDI to a first default value (e.g., 1 or 0) indicating the new HARQ transmission carrying the MBS data packet(s). Then the base station at block 708 generates a first DCI command including the first NDI set to the first default value. The first DCI command assigns a first PDSCH carrying the new HARQ transmission. The base station at block 710 generates a first CRC for the first DCI command, where the first CRC is scrambled with a MBS-RNTI (e.g., MBS-RNTI K). The base station at block 712 transmits the first DCI command and its scrambled first CRC to the UE on the first PDCCH, as well as the first HARQ transmission on the first PDSCH.

If the base station at block 714 receives a HARQ NACK from the UE, indicating that the UE failed to successfully receive the first HARQ transmission, the base station at block 716 prepares to retransmit the first HARQ transmission as a second HARQ transmission (i.e., a HARQ retransmission). Then the base station at block 718 sets a second NDI to a second default value (e.g., 1 if the first NDI was set to 0, or 0 if the first NDI was set to 1) indicating the second HARQ transmission as a HARQ retransmission carrying the MBS data packet(s). Then the base station at block 720 generates a second DCI command including the second NDI set to the second default value. The second DCI command assigns a second PDSCH carrying the second HARQ transmission. The base station at block 722 generates a second CRC for the second DCI command, where the second CRC is scrambled with an RNTI (e.g., C-RNTI) typically used for unicast communication. The base station at block 724 transmits the second DCI command and its scrambled second CRC to the UE on the second PDCCH, as well as the second HARQ transmission on the second PDSCH.

If the base station does not receive a HARQ NACK from the UE (i.e., the UE successfully received the second HARQ transmission), the base station can obtain additional data packet(s). If the base receives a HARQ NACK from the UE, the base station can prepare to retransmit the second HARQ transmission in another HARQ retransmission, by proceeding to block 716.

Referring now to FIG. 8, an example method 800 can be implemented in a base station (e.g., base station 104) for retransmitting MBS information and/or non-MBS (i.e., unicast) information as a HARQ retransmission to a plurality of UEs (e.g., UE 102).

Initially, a base station transmits MBS data packet(s) and/or unicast data packet(s) in a HARQ transmission to the plurality of UEs pursuant to the HARQ process. If the base station configured different PUCCHs for respective UEs, enabling each of the UEs to transmit HARQ feedback on a unique PUCCH, the base station can determine which particular UE did not successfully receive the HARQ transmission, by identifying the particular PUCCH on which the base station receives the HARQ NACK. Accordingly, instead of retransmitting the MBS data packet(s) and/or unicast data packet(s) to the plurality of UEs, the base station can retransmit the MBS data packet(s) and/or unicast data packet(s) to the particular UE (e.g., UE 102A or UE 102B) that transmitted the HARQ NACK on the particular PUCCH.

At block 802, the base station determines to retransmit the MBS data packet(s) and/or unicast data packet(s) to the particular UE as a HARQ retransmission.

At block 804, the base station determines whether the data packet(s) to be transmitted in a HARQ retransmission to the UE are MBS data packet(s) or unicast data packet(s).

If the base station at block 804 determines that the data packet(s) to be transmitted in a HARQ retransmission to the UE are MBS data packet(s), the base station at block 806 sets an NDI to a default value (e.g., 1 or 0) indicating the HARQ retransmission carrying the MBS data packet(s). Then the base station at block 810 generates a DCI command including the NDI set to the default value. The DCI command assigns a PDSCH carrying the HARQ retransmission. The base station at block 812 generates a CRC for the DCI command, where the CRC is scrambled with an RNTI (e.g., C-RNTI) typically used for unicast communication. In this way, the base station can generate the CRC specifically for the particular UE that transmitted the HARQ NACK on the particular PUCCH prior to block 802. The particular UE is aware of the RNTI (e.g., C-RNTI) used by the base station to scramble the CRC. The base station at block 814 transmits the DCI command and its scrambled CRC to the particular UE on a PDCCH, as well as the HARQ retransmission on the PDSCH. Accordingly, instead of retransmitting the MBS data packet(s) to the plurality of UEs, the base station can retransmit the MBS data packet(s) to the particular UE that transmitted the HARQ NACK on the particular PUCCH.

Referring back to block 804, if the base station at block 804 determines that the data packet(s) to be transmitted in a HARQ retransmission to the UE are unicast data packet(s), the base station at block 808 sets an NDI to an un-toggled value (e.g., 1 or 0) indicating the HARQ retransmission carrying the unicast data packet(s). Then the base station at block 810 generates a DCI command including the NDI set to the un-toggled value. The DCI command assigns a PDSCH carrying the HARQ retransmission. The base station at block 812 generates a CRC for the DCI command, where the CRC is scrambled with an RNTI (e.g., C-RNTI) typically used for unicast communication. The base station at block 814 transmits the DCI command and its scrambled CRC to the particular UE on a PDCCH, as well as the HARQ retransmission on the PDSCH.

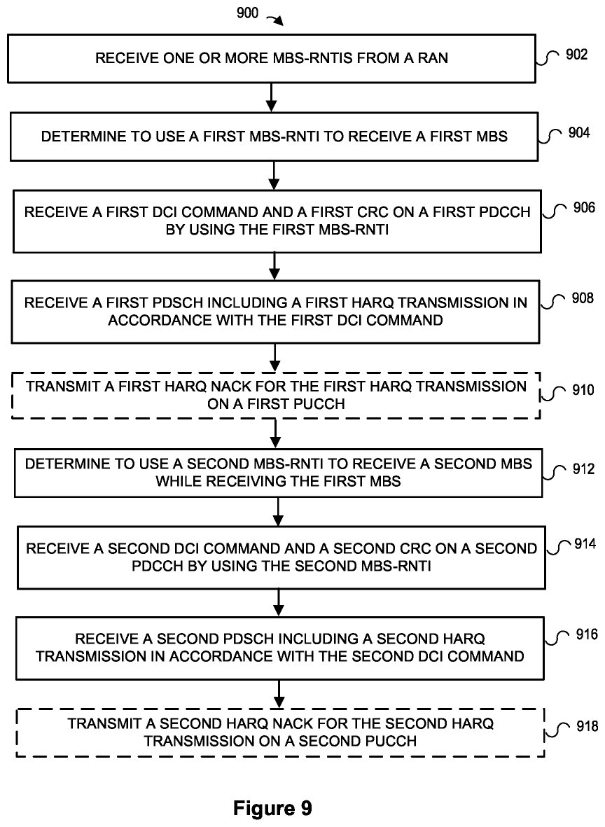

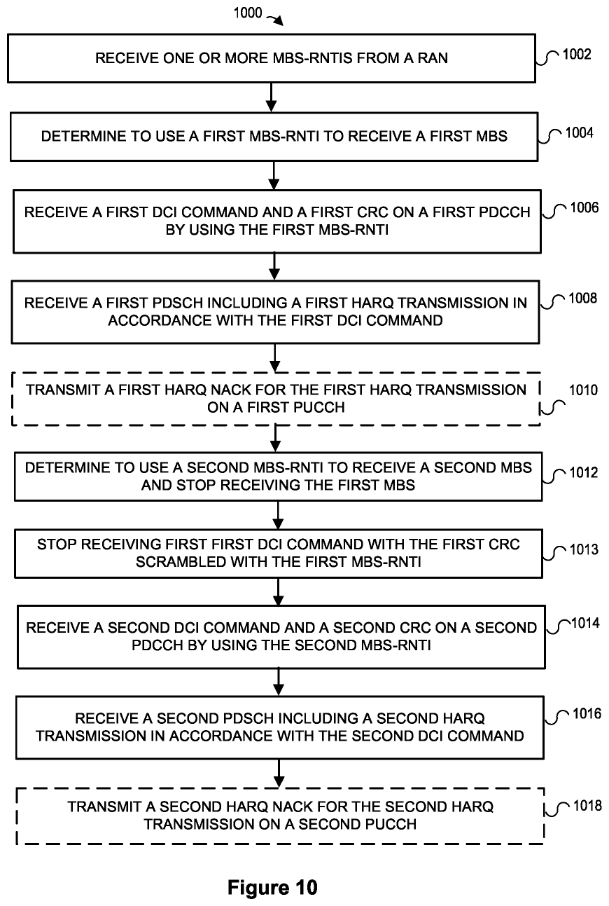

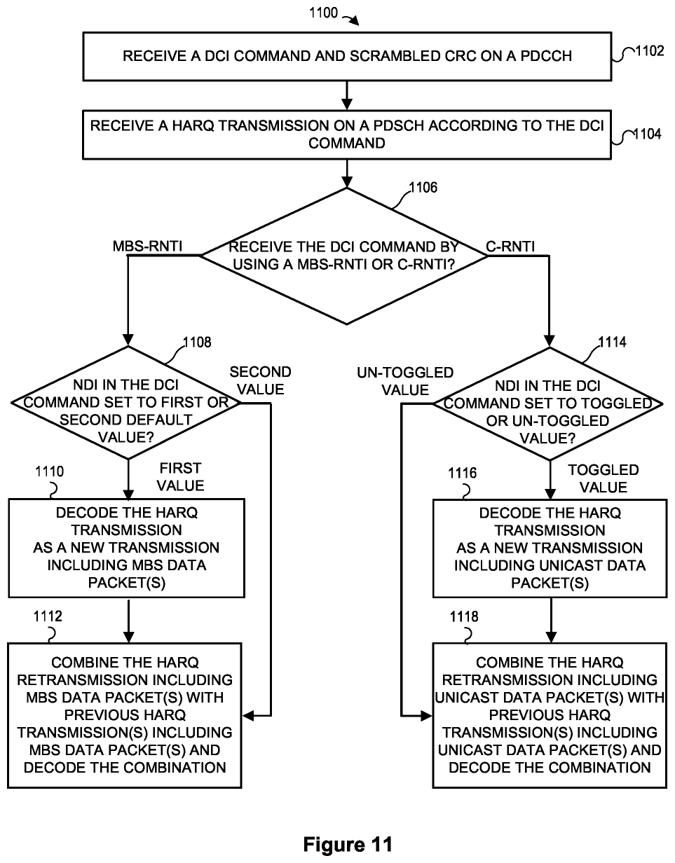

Now referring to FIGS. 9-11, several example methods that the UE 102 of this disclosure can implement are considered next. Each of these methods can be implemented using suitable processing hardware such as for example one or more processors configured to execute instructions stored on a non-transitory computer-readable medium. Particularly, in FIG. 9, the UE 102 uses two different MBS-RNTIs to receive MBS data packets for two different MBSs using a HARQ process. In FIG. 10, the UE 102 switches from one MBS-RNTI to another different MBS-RNTI to receive MBS data packets for two different MBSs using a HARQ process. In FIG. 11, the UE 102 receives unicast data packets and/or MBS data packets from the RAN 105 using a HARQ process.

Referring now to FIG. 9, an example method 900 can be implemented in a UE (e.g., UE 102) for receiving MBS information from a RAN (e.g., RAN 105) using a HARQ process.

At block 902, a UE receives one or more MBS-RNTIs (i.e., MBS-RNTIs 1, 2, . . . N, where N is greater than 1) from a RAN (e.g., in events 302, 303, 305). Each of the N MBS-RNTIs corresponds to respective MBSs (i.e., a first MBS, a second MBS, . . . an N-th MBS), so that the UE can receive MBS packets (i.e., a first stream of MBS packets for the first MBS, a second stream of MBS packets for the second MBS, . . . an N-th stream of MBS packets for the N-th MBS) from the RAN. The UE can use the MBS-RNTI(s) to receive the MBS packets from the RAN later on.

At block 904, the UE determines to use a first MBS-RNTI (e.g., MBS-RNTI 1) to receive a first MBS. When the UE at block 906 receives a first DCI command and a first CRC (scrambled by the RAN using the first MBS-RNTI) on a first PDCCH from the RAN (e.g., in event 310), the UE can use the first MBS-RNTI to de-scramble the scrambled first CRC, so that the UE can recognize (and be aware of) the first PDSCH assigned by the first DCI command on which the RAN transmits the first MBS. At block 908, the UE receives the first PDSCH, including a first HARQ transmission of the first MBS, in accordance with the first DCI command (e.g., in event 312).

The UE may successfully receive one, some, or all of the MBS data packets in the HARQ transmissions. For any MBS data packet(s) of the first MBS that the UE does not successfully receive from the RAN, the UE at block 910 can transmit a first HARQ NACK to the RAN, which in turn can retransmit the MBS data packet(s) of the first MBS the UE failed to receive. The RAN may have assigned one or more PUCCHs corresponding to the one or more MBS-RNTI(s) to the UE, so that the UE can report HARQ NACKs on the one or more PUCCHs if the UE does not successfully receive the MBS data packet(s). That is, the UE can report the first HARQ NACK on a first PUCCH if the UE does not successfully receive the first MBS. If the UE fails to receive an MBS (e.g., a second MBS) different than the first MBS, the UE can report a second HARQ NACK on a second PUCCH if the UE does not successfully receive the second MBS.

If the UE received more than one MBS-RNTI at block 902, such as a second MBS-RNTI, the UE at block 912 can determine to use the second MBS-RNTI (e.g., MBS-RNTI 2) to receive the second MBS. By using the second MBS-RNTI (while continuing to use the first MBS-RNTI), the UE can receive the second MBS while continuing to use the first MBS-RNTI to receive the first MBS. When the UE at block 914 receives a second DCI command and a second CRC (scrambled by the RAN using the second MBS-RNTI) on a second PDCCH from the RAN (e.g., in event 310), the UE can use the second MBS-RNTI to de-scramble the scrambled second CRC, so that the UE can recognize (and be aware of) the second PDSCH assigned by the second DCI command on which the RAN transmits the second MBS. At block 916, the UE receives the second PDSCH, including a second HARQ transmission of the second MBS, in accordance with the second DCI command (e.g., in event 312).

For any MBS data packet(s) of the second MBS that the UE does not successfully receive from the RAN, the UE at block 918 can transmit a second HARQ NACK on the second PUCCH to the RAN, which in turn can retransmit the MBS data packet(s) of the second MBS the UE failed to receive.

Referring now to FIG. 10, whereas the UE of FIG. 9 can use the first MBS-RNTI and the second MBS-RNTI to receive the first MBS and second MBS, respectively, the UE of FIG. 10 switches from using the first MBS-RNTI to the second MBS-RNTI, and thus receives the second MBS while not receiving the first MBS. Otherwise, any of the implementations described above in reference to FIG. 9 can be applied to method 1000 of FIG. 10.

At block 1002, a UE receives one or more MBS-RNTIs from a RAN, similar to block 902.

At block 1004, the UE determines to use a first MBS-RNTI to receive a first MBS, similar to block 904. Similar to block 906, when the UE at block 1006 receives a first DCI command and a first CRC (scrambled by the RAN using the first MBS-RNTI) on a first PDCCH from the RAN, the UE can use the first MBS-RNTI to de-scramble the scrambled first CRC, so that the UE can recognize (and be aware of) the first PDSCH assigned by the first DCI command on which the RAN transmits the first MBS. At block 1008, the UE receives the first PDSCH, including a first HARQ transmission of the first MBS, in accordance with the first DCI command, similar to block 908.

For any MBS data packet(s) of the first MBS that the UE does not successfully receive from the RAN, the UE at block 1010 can transmit a first HARQ NACK on a first PUCCH to the RAN, which in turn can retransmit the MBS data packet(s) of the first MBS the UE failed to receive, similar to block 910.

If the UE received more than one MBS-RNTI at block 1002, such as a second MBS-RNTI, the UE at block 1012 can determine to use the second MBS-RNTI to receive a second MBS, similar to block 912. By using the second MBS-RNTI (after stopping to use the first MBS-RNTI), the UE can receive the second MBS after stopping to use the first MBS-RNTI to receive the first MBS. Therefore, the UE at block 1013 stops receiving the first DCI command and the first CRC scrambled with the first MBS-RNTI to stop receiving the first MBS in a HARQ retransmission. In some implementations, the UE can discard the first MBS-RNTI after determining to use the second MBS-RNTI.

When the UE at block 1014 receives a second DCI command and a second CRC (scrambled by the RAN using the second MBS-RNTI) on a second PDCCH from the RAN (e.g., in event 310), the UE can use the second MBS-RNTI to de-scramble the scrambled second CRC, so that the UE can recognize (and be aware of) the second PDSCH assigned by the second DCI command on which the RAN transmits the second MBS, similar to block 914. At block 1016, the UE receives the second PDSCH, including a second HARQ transmission of the second MBS, in accordance with the second DCI command (e.g., in event 312), similar to block 916.

For any MBS data packet(s) of the second MBS that the UE does not successfully receive from the RAN, the UE at block 1018 can transmit a second HARQ NACK on a second PUCCH to the RAN, which in turn can retransmit the MBS data packet(s) of the second MBS the UE failed to receive, similar to block 918.

Referring now to FIG. 11, an example method 1100 can be implemented in a UE (e.g., UE 102) for receiving MBS information and/or non-MBS (i.e., unicast) information from a RAN (e.g., RAN 105) using a HARQ process.

At block 1102, the UE receives a DCI command and its scrambled CRC on a PDCCH from the RAN (e.g., in event 310), and at block 1104, a HARQ transmission on a PDSCH, in accordance with the DCI command, pursuant to the HARQ process (e.g., in event 312).

At block 1106, the UE determines whether to use an MBS-RNTI or a C-RNTI when receiving the DCI command (i.e., de-scramble its scrambled CRC), so that the UE can successfully receive the HARQ transmission. Alternatively, the UE at block 1106 can determine whether to perform a HARQ process specifically for MBS.

To assist the UE in determining whether the DCI command is for a HARQ transmission (i.e., a new HARQ transmission that has not been previously transmitted to the UE) carrying MBS data packet(s) or unicast data packet(s), or a HARQ retransmission carrying MBS data packet(s) or unicast data packet(s), the base station can specify an appropriate NDI in the DCI command. For example, the base station can set the NDI to a first default value to indicate that the HARQ transmission is a new HARQ transmission carrying the MBS data packet(s), or to a second default value to indicate that the HARQ transmission is a HARQ retransmission carrying the MBS data packet(s). As another example, the base station can set the NDI to toggled value to indicate that the HARQ transmission is a new HARQ transmission carrying the unicast data packet(s), or to an un-toggled value to indicate that the HARQ transmission is a HARQ retransmission carrying the unicast data packet(s). As such, if the UE at block 1106 determines to use the MBS-RNTI when receiving the command (or alternatively, determines to perform a HARQ process specifically for MBS), the UE at block 1108 determines whether the NDI value in the DCI command is set to a first default value or the second default value. Consequently, if the UE at block 1108 determines that the NDI value is set to the first default value, the UE at block 1110 decodes the received HARQ transmission as a new HARQ transmission including MBS data packet(s). If the UE at block 1108 determines that the NDI value is set to the second default value, the UE is aware that the received HARQ transmission is a HARQ retransmission including MBS data packet(s). Accordingly, the UE at block 1112 combines (e.g., soft-combines) the HARQ retransmission including MBS data packet(s) with a previously received HARQ transmission including MBS data packet(s) to decode the combination, pursuant to the HARQ process.

Referring back to block 1106, if the UE at block 1106 determines to use the C-RNTI when receiving the command (or alternatively, determines not to perform a HARQ process specifically for MBS), the UE determines whether the NDI value in the DCI command is set to a toggled value or un-toggled value. Consequently, if the UE at block 1114 determines that the NDI value is set to the toggled value, the UE at block 1116 decodes the received HARQ transmission as a new HARQ transmission including unicast data packet(s). If the UE at block 1108 determines that the NDI value is set to the un-toggled value, the UE is aware that the received HARQ transmission is a HARQ retransmission including unicast data packet(s). Accordingly, the UE at block 1118 combines (e.g., soft-combines) the HARQ retransmission including unicast data packet(s) with a previously received HARQ transmission including unicast data packet(s) to decode the combination, pursuant to the HARQ process.

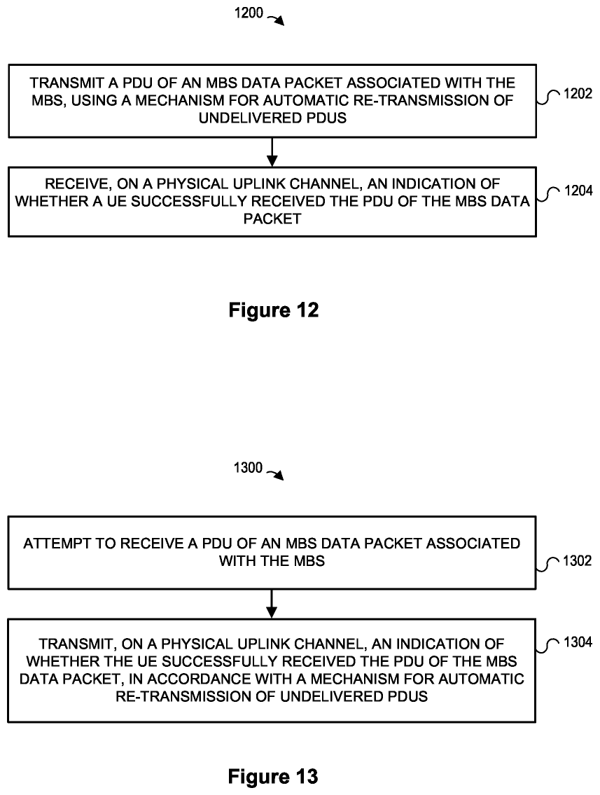

FIG. 12 is a flow diagram of an example method 1200 implemented in a base station (e.g., base station 104) for providing MBS.

At block 1202, a base station transmits a PDU of an MBS data packet associated with a MBS, using a mechanism for automatic re-transmission of undelivered PDUs (e.g., in events or blocks 312, 320, 410A, 418A, 410B, 418B, 512A, 514A, 518A, 520A, 522A, 512B, 514B, 518B, 520B, 618, 632, 712, 724, 814).

At block 1204, the base station receives, on a physical uplink channel, an indication of whether a UE (e.g., UE 102) successfully received the PDU of the MBS data packet (e.g., in events or blocks 314, 316, 322, 324, 412A, 412B, 516A, 516B, 620, 634, 714).

FIG. 13 is a flow diagram of an example method 1300 implemented in a UE (e.g., UE 102) for receiving MBS.

At block 1302, a UE attempts to receive from a base station (e.g., base station 104), a PDU of an MBS data packet associated with the MBS (e.g., in events or blocks 312, 320, 908, 916, 1008, 1016, 1104).

At block 1304, the UE transmits, on a physical uplink channel and to the base station, an indication of whether the UE successfully received the PDU of the MBS data packet, in accordance with a mechanism for automatic re-transmission of undelivered PDUs (e.g., in events or blocks 314, 316, 322, 324, 910, 918, 1010, 1018).

The following additional considerations apply to the foregoing discussion.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

Upon reading this disclosure, those of skill in the art will appreciate still additional alternative structural and functional designs for managing HARQ transmissions through the disclosed principles herein. Thus, while particular embodiments and applications have been illustrated and described, it is to be understood that the disclosed embodiments are not limited to the precise construction and components disclosed herein. Various modifications, changes and variations, which will be apparent to those of ordinary skill in the art, may be made in the arrangement, operation and details of the method and apparatus disclosed herein without departing from the spirit and scope defined in the appended claims.

Example 1. A method in a base station for providing a multicast and/or broadcast service (MBS), the method comprising: transmitting, by a processing hardware of the base station, a protocol data unit (PDU) of an MBS data packet associated with the MBS, using a mechanism for automatic re-transmission of undelivered PDUs; and receiving, by the processing hardware on a physical uplink channel and from at least one of the plurality of UEs, an indication of whether a UE successfully received the PDU of the MBS data packet.

Example 2. The method of example 1, further comprising: providing, by the processing hardware and to the plurality of UEs, a configuration of resources for (i) receiving the PDU of the MBS data packet from the base station and (ii) transmitting the indication to the base station.

Example 3. The method of example 2, wherein providing the configuration further comprises: transmitting a set of one or more MBS radio network temporary identifiers (MBS-RNTIs), each of the MBS-RNTIs corresponding to a respective MBS.

Example 4. The method of example 3, wherein transmitting the set of one or more MBS-RNTIs further comprises: broadcasting a system information message including the set of one or more MBS-RNTIs.

Example 5. The method of example 3, wherein transmitting the set of one or more MBS-RNTIs further comprises: transmitting, to each of the plurality of UEs, a respective message associated with a protocol for controlling radio resources, the respective message including the set of one or more MBS-RNTIs.

Example 6. The method of any of the preceding examples, further comprising: transmitting, by the processing hardware and to the plurality of UEs, downlink control information (DCI) to specify a downlink resource over which the PDU of the MBS data packet is transmitted.

Example 7. The method of example 6, further comprising: scrambling a cyclic redundancy check (CRC) field, using an MBS radio network temporary identifier (MBS-RNTI) with which the PDU of the MBS data packet is associated, to generate a scrambled CRC; and transmitting the scrambled CRC with the DCI.

Example 8. The method of any of examples 2-7, wherein providing the configuration further comprises: transmitting, to the plurality of UEs, an indication of a shared uplink channel for reporting positive and/or negative acknowledgements for respective MBS data packets of a plurality of MBSs.

Example 9. The method of any of examples 2-7, wherein providing the configuration further comprises: transmitting, to the plurality of UEs for each of a multiplicity of MBSs, an indication of a respective uplink channel for reporting positive and/or negative acknowledgements for the MBS data packet of the respective MBS.

Example 10. The method of example 8 or 9, wherein the uplink channel is a Physical Uplink Control Channel (PUCCH).

Example 11. The method of any of the preceding examples, wherein: the received indication indicates that at least one of the plurality of UEs has not received the PDU of the MBS data packet; and in response to the received indication, re-transmitting the PDU of the MBS data packet using the mechanism for automatic re-transmission of undelivered PDUs.

Example 12. The method of example 11, wherein: transmitting the PDU of the MBS data packet includes transmitting the PDU of the MBS data packet with a new data indicator (NDI) set to a first default value; and re-transmitting the PDU of the MBS data packet includes re-transmitting the PDU of the MBS data packet with the NDI set to a second default value.

Example 13. The method of example 11, wherein: transmitting the PDU of the MBS data packet includes transmitting the PDU of the MBS data packet with an NDI set to an un-toggled value; and re-transmitting the PDU of the MBS data packet includes re-transmitting the PDU of the MBS data packet with the NDI set to a toggled value.

Example 14. The method of example 11, further comprising: sending, to one of the plurality of UEs, a PDU of a unicast data packet using the mechanism for automatic re-transmission of undelivered PDUs, including setting the new data indicator for the PDU of the unicast data packet to a toggled value; and re-sending, to the one of the plurality of UEs, the PDU of the unicast data packet using the mechanism for automatic re-transmission of undelivered PDUs, including setting the new data indicator for the PDU of the unicast data packet to an un-toggled value.

Example 15. The method of example 11, wherein: transmitting the PDU of the MBS data packet includes an MBS-RNTI; and re-transmitting the PDU of the MBS data packet includes using a cell RNTI (C-RNTI) of the UE from which the indication is received.

Example 16. The method of any of the preceding examples, wherein: the MBS data packet is a first MBS data packet associated with a first MBS, and the DCI is a first DCI; the method further comprising: transmitting, by the processing hardware and to the plurality of UEs, a second DCI for a second MBS data packet associated with a second MBS; and transmitting, by the processing hardware and using the mechanism for automatic re-transmission of undelivered PDUs, the second MBS data packet.

Example 17. The method of any of the preceding examples, wherein using the mechanism for automatic re-transmission of undelivered PDUs includes using a Hybrid Automatic Repeat Request (HARD) technique.

Example 18. A base station comprising processing hardware and configured to implement a method of any of the preceding examples.

Example 19. A method in a user equipment (UE) for receiving a multicast and/or broadcast service (MBS), the method comprising: attempting to receive, by processing hardware and from a base station, a PDU of an MBS data packet associated with the MBS; and transmitting, by the processing hardware on a physical uplink channel and to the base station, an indication of whether the UE successfully received the PDU of the MBS data packet, in accordance with a mechanism for automatic re-transmission of undelivered PDUs.

Example 20. The method of example 19, further comprising: receiving, by the processing hardware and from the base station, a configuration of resources for (i) receiving the PDU of the MBS data packet from the base station and (ii) transmitting the indication to the base station.

Example 21. The method of example 20, wherein receiving the configuration includes: receiving a set of one or more MBS-RNTIs, each of the MBS-RNTIs corresponding to a respective MBS.

Example 22. The method of example 21, wherein receiving the set of one or more MBS-RNTIs includes receiving a broadcast of a system information message including the set of one or more MBS-RNTIs.

Example 23. The method of example 21, wherein receiving the set of one or more MBS-RNTIs includes receiving a message associated with a protocol for controlling radio resources, the message including the set of one or more MBS-RNTIs.

Example 24. The method of any of the preceding examples, further comprising: receiving, by the processing hardware, a DCI to specify a downlink resource over which the PDU of the MBS data packet is transmitted.

Example 25. The method of example 24, further comprising: receiving a scrambled CRC with the DCI; and unscrambling the CRC using an MBS-RNTI with which the PDU of the MBS data packet is associated.

Example 26. The method any of examples 20-25, wherein receiving the configuration includes: receiving an indication of a shared uplink channel for reporting positive and/or negative acknowledgements for a plurality of MBSs.

Example 27. The method any of examples 20-25, wherein receiving the configuration includes: receiving, for each of a multiplicity of MBSs, an indication of a respective uplink channel for reporting positive and/or negative acknowledgements associated with the MBS.

Example 28. The method of example 26 or 27, wherein the uplink channel is a PUCCH.

Example 29. The method of any of examples 19-28, wherein: the indication includes a negative acknowledgement; receiving, in response to the indication, a re-transmission of the PDU of the MBS data packet, in accordance with the mechanism for automatic re-transmission of undelivered PDUs.

Example 30. The method of example 29, wherein using the mechanism for automatic re-transmission of undelivered PDUs includes: attempting to receive the PDU of the MBS data packet with a new data indicator set to a first default value; and receiving the re-transmission of the PDU of the MBS data packet with the new data indicator set to a second default value.

Example 31. The method of example 30, further comprising: attempting to receive a PDU of a unicast data packet in accordance with the mechanism for automatic re-transmission of undelivered PDUs, with the new data indicator for the PDU of the unicast data packet set to a toggled value; and receiving a re-transmission of the PDU of the unicast data packet, in accordance with the mechanism for automatic re-transmission of undelivered PDUs, with the new data indicator for the PDU of the unicast data packet set to an un-toggled value.

Example 32. The method of example 29, wherein: attempting to receive the PDU of the MBS data packet includes using an MBS-RNTI; and receiving a re-transmission of the PDU of the MBS data packet includes using a C-RNTI.

Example 33. The method of example 29, wherein: attempting to receive the PDU of the MBS data packet includes using a first MBS-RNTI; and receiving a re-transmission of the PDU of the MBS data packet includes using a second MBS-RNTI.

Example 34. The method of any of examples 19-33, wherein: the MBS data packet is a first MBS data packet associated with a first MBS, and the DCI is a first DCI; the method further comprising: receiving, by the processing hardware and the plurality of UEs, a second DCI for a second MBS data packet associated with a second MBS; and receiving, by the processing hardware and in accordance with the mechanism for automatic re-transmission of undelivered PDUs, the second MBS data packet.

Example 35. A UE comprising processing hardware and configured to implement a method of any of examples 18-34.

1. A method in a base station for providing multicast and/or broadcast services (MBSs), the method comprising:
transmitting, by the base station and to each of a plurality of UEs, a respective message associated with a protocol for controlling radio resources, the respective message including a set of two or more group radio network temporary identifiers (G-RNTIs), each G-RNTI of the set of G-RNTIs corresponding to a respective MBS; and
subsequent to the transmitting of the respective messages including the set of G-RNTIs:
first transmitting, by the the base station and to at least one of the plurality of UEs, a first protocol data unit (PDU) of an MBS data packet associated with a first MBS, the first transmitting based on a first G-RNTI of the set of G-RNTIs, and the first transmitting using a mechanism for automatic re-transmission of undelivered PDUs;
receiving, by the base station on a physical uplink channel and from the at least one of the plurality of UEs, an indication of whether a UE successfully received the first PDU of the MBS data packet; and
second transmitting, by the base station to one or more of the plurality of UEs, another PDU that is associated with the first MBS or with a second MBS, the second transmitting based on a second G-RNTI of the set of G-RNTIs.

2. The method of claim 1, further comprising:
providing, by the base station and to the plurality of UEs, a configuration of resources for (i) receiving the first PDU of the MBS data packet from the base station and (ii) transmitting the indication to the base station.

3. The method of claim 1, further comprising:
scrambling a cyclic redundancy check (CRC) field, using the first G-RNTI with which the first PDU of the MBS data packet is associated, to generate a scrambled CRC; and
transmitting the scrambled CRC with downlink control information (DCI), the DCI specifying a downlink resource over which the first PDU of the MBS data packet is transmitted.

4. The method of claim 2, wherein the providing of the configuration further comprises:
transmitting, to the plurality of UEs, an indication of a shared uplink channel for reporting positive and/or negative acknowledgements.

5. The method of claim 4, wherein the shared uplink channel is a Physical Uplink Control Channel (PUCCH).

6. The method of claim 1, wherein:
the received indication indicates that the UE has not successfully received the first PDU of the MBS data packet; and
in response to the received indication, re-transmitting the first PDU of the MBS data packet using the mechanism for automatic re-transmission of undelivered PDUs.

7. The method of claim 6, wherein:
the first transmitting of the first PDU of the MBS data packet includes transmitting the first PDU of the MBS data packet with a new data indicator (NDI) set to a first default value; and
the re-transmitting of the first PDU of the MBS data packet includes re-transmitting the first PDU of the MBS data packet with the NDI set to a second default value.

8. The method of claim 6, wherein:
the first transmitting of the first PDU of the MBS data packet includes transmitting the first PDU of the MBS data packet with an NDI set to an un-toggled value; and
the re-transmitting of the first PDU of the MBS data packet includes re-transmitting the first PDU of the MBS data packet with the NDI set to a toggled value.

9. The method of claim 1, wherein the using of the mechanism for automatic re-transmission of undelivered PDUs includes using a Hybrid Automatic Repeat Request (HARQ) technique.

10. The method of claim 1, wherein the respective message includes a command for modifying a radio resource control (RRC) connection.

11. A base station comprising processing hardware and configured to implement the method of claim 1.

12. A method in a user equipment (UE) for receiving multicast and/or broadcast services (MBSs), the method comprising:
receiving, by the UE and from a base station, a message associated with a protocol for controlling radio resources, the message including a set of two or more group radio network temporary identifiers (G-RNTIs), each G-RNTI of the set of G-RNTIs corresponding to a respective MBS; and
subsequent to the receiving of the message;
first attempting to receive, by the UE and from the base station, a first protocol data unit (PDU) of an MBS data packet associated with a first MBS, the first attempting to receive based on a first G-RNTI of the set of G-RNTIs, and the first G-RNTI corresponding to the first MBS;
transmitting, by the UE on a physical uplink channel and to the base station, an indication of whether the UE successfully received the first PDU of the MBS data packet, in accordance with a mechanism for automatic re-transmission of undelivered PDUs; and
second attempting to receive, by the UE and from the base station, another PDU associated with the first MBS or with a second MBS, the second attempting to receive based on a second G-RNTI of the set of G-RNTIs.

13. The method of claim 12, further comprising:
receiving, by the UE and from the base station, a configuration of resources for (i) receiving the first PDU of the MBS data packet from the base station and (ii) the transmitting of the indication to the base station.

14. The method of claim 12, further comprising:
receiving, with downlink control information (DCI), a CRC that has been scrambled using the first G-RNTI corresponding to the first MBS, the DCI specifying a downlink resource over which the first PDU of the MBS data packet is transmitted; and
unscrambling the CRC using the first G-RNTI with which the first PDU of the MBS data packet is associated.

15. The method of claim 13, wherein receiving the configuration includes:
receiving an indication of an uplink channel for reporting positive and/or negative acknowledgements.

16. A UE comprising processing hardware and configured to implement the method of claim 12.

17. The method of claim 12, further comprising stopping the first attempting to receive the PDU prior to executing the second attempting to receive.

18. The method of claim 12, wherein the method executes at least a part of the second attempting to receive while the method is executing at least a part of the first attempting to receive.

19. The method of claim 1, wherein:
the received indication indicates that the UE has not successfully received the first PDU; and
the second transmitting of the another PDU associated with the first MBS or with the second MBS is in response to the received indication and includes re-transmitting, based on the second G-RNTI, the first PDU of the MBS data packet associated with the first MBS using the mechanism for automatic re-transmission of undelivered PDUs.

20. The method of claim 1, wherein the second transmitting of the another PDU associated with the first MBS or with the second MBS includes:
transmitting a second PDU of the MBS data packet associated with the first MBS;
transmitting a PDU of another MBS data packet associated with the first MBS; or
transmitting a PDU of an MBS data packet associated with the second MBS.
